(19) United States
(12) Patent Application Publication
(10) Pub. No.: US 2026/0141684 A1
(43) Pub. Date: May 21, 2026

(54) ONLINE SERVICE PROVIDER (OSP) DETERMINING A RESOURCE FOR A SUBJECT ASSOCIATED WITH A RELATIONSHIP INSTANCE BASED ON IMAGE(S) OF SUBJECTS OF THE RELATIONSHIP INSTANCE AND TRANSFER OF THE RESOURCE TO A DOMAIN

(71) Applicant: Avalara, Inc., Seattle, WA (US)

(72) Inventors: Jayme Fishman, Boxford, MA (US); David Berthiaume, Newton, MA (US); Thomas Goldschmidt, Karlsdorf-Neuthard (DE)

(21) Appl. No.: 19/382,061

(22) Filed: Nov. 6, 2025

Related U.S. Application Data
(60) Provisional application No. 63/721,087, filed on Nov. 15, 2024.

(51) Int. Cl. G06V 10/764; G06T 7/50

(52) U.S. Cl. CPC G06V 10/764; G06T 7/50; G06T 2207/20081

(57) ABSTRACT

Systems and methods electronically generate a classification code for an item by initially classifying the item based on item-sensed data for the item and refining the classification of the item based on attributes of a proposed relationship instance associated with the item. Entities are often required to identify a classification code for items that are the subject of a relationship instance. The systems and methods described herein allow entities to easily obtain classification codes for items that are the subject of a relationship instance.

### CROSS-REFERENCE TO RELATED APPLICATIONS

This patent application claims the benefit of U.S. Provisional Application No. 63/721,087 filed on Nov. 15, 2024. This patent application incorporates by reference from U.S. patent application Ser. No. 18/318,514, filed on May 16, 2023. In situations where the present document and any document incorporated by reference conflict, the present document controls.

### BACKGROUND

Items associated with relationship instances between entities in different jurisdictions are classified to determine whether a resource associated with the relationship instance is to be transferred to an entity. The classification represents one or more attributes of the item.

All subject matter discussed in this Background section of this document is not necessarily prior art, and may not be presumed to be prior art simply because it is presented in this Background section. Plus, any reference to any prior art in this description is not, and should not be taken as, an acknowledgement or any form of suggestion that such prior art forms parts of the common general knowledge in any art in any country. Along these lines, any recognition of problems in the prior art discussed in this Background section or associated with such subject matter should not be treated as prior art, unless expressly stated to be prior art. Rather, the discussion of any subject matter in this Background section should be treated as part of the approach taken towards the particular problem by the inventors. This approach in and of itself may also be inventive.

### BRIEF SUMMARY

The present description gives instances of computer systems, storage media that may store programs, and methods. Embodiments of the system classify an item associated with a relationship instance based on an item-sensed data of an item received from a primary entity. The item-sensed data is applied to a first classification model to obtain an initial classification, and the initial classification and attributes of the relationship instance are applied to a second classification model to obtain a refined classification. The refined classification is used to identify one or more digital rules, which are applied to the relationship instance. The initial classification, refined classification, digital rules, or some combination thereof, may be used to determine one or more classification codes for an item. By accurately classifying the item based on the item-sensed data, the system is able to determine whether a resource is able to be transferred to an entity as a result of the relationship instance.

Providing, in a timely and efficient manner, accurate and reliable classification codes to determine whether a resource is able to be transferred to an entity as a result of a relationship instance presents a technical problem for primary entities. Such classification codes are dependent on the attributes of the items, attributes of relationship instances that include the items, and digital rules related to the classification codes and domains. Current methods of determining a classification code for an item involve subject-matter experts analyzing data regarding the item to 1) identify the item, 2) classify the items for each domain that has a classification code system, 3) store the classification of those items within many databases, and 4) retrieve and apply digital rules associated with the classification codes for each classification. The subject-matter experts determine which classification codes apply to the item based on attributes of the items. Furthermore, primary entities must update their classification codes each time a new item is identified by a primary entity. Computing resources, such as processing power and memory to facilitate user interfaces and data transmission between each entity associated with the relationship instance, are expended in supporting the subject-matter expert to determine the classification codes. Additionally, because the subject-matter expert determines the classification codes, the entities must wait until the expert has made their determination before digital rules regarding the relationship instance can be determined and before the relationship instance can proceed. Furthermore, classification codes must be updated for each new item identified by a primary entity as an item that may be subject to a relationship instance, and old classification codes must also be stored by the primary entity for items already identified by the primary entity, which results in the need for additional computing resources, such as: 1) processing and memory resources to compile and display data related to items for the subject-matter expert to analyze and classify the item as being defined by a plurality of classification codes, 2) memory resources to store each classification code for every item that may be subject to a relationship instance involving the primary entity, and 3) processing and memory resources to locate and retrieve classification code for each item subjected to a relationship instance.

In embodiments, the system accesses a dataset that indicates a relationship instance between a primary entity associated with a first domain and a secondary entity associated with a second domain. The system extracts item-sensed data indicative of one or more items from the dataset. The system applies the item-sensed data to a first classification machine learning model to obtain an initial classification of the item. In some embodiments, the item-sensed data includes an image of the item. In some embodiments, the item-sensed data includes a depth map of the item. In some embodiments, the initial classification of the item includes one or more classification codes for the item.

Additionally, the system extracts one or more attributes of the relationship instance from the dataset. In some embodiments, one or more attributes of the relationship instance include: a location associated with the relationship instance, an entity type of the primary entity, an entity type of the secondary entity, a weight of one or more items associated with the relationship instance, a shape of one or more items associated with the relationship instance, a number of items associated with the relationship instance, other attributes of a relationship instance, or some combination thereof. The system applies the attributes related to the relationship instance and the initial classification of the item to a second classification machine learning model to generate a refined classification of the item. In some embodiments, the refined classification of the item includes one or more classification codes for the item. In some embodiments, the initial classification, refined classification, or some combination thereof, include one or more probabilities that the item is defined by a classification code for each of the classification codes determined by the first or second classification model.

The system looks up one or more digital rules applying to the relationship instance based on the refined classification and the attributes of the relationship instance. The system generates a response to the dataset based on the one or more digital rules and the refined classification of the item.

Furthermore, in some embodiments, the system determines a resource, or a portion of a resource, associated with the relationship instance based on the refined classification of the item and the digital rules. In some embodiments, the system identifies a first domain associated with a primary entity and a second domain associated with the secondary entity based on the relationship instance. In some embodiments, the system determines whether, as a result of the relationship instance, at least a portion of the resource is able to be transferred to a third entity associated with at least one of the first and second domains. In such embodiments, the system may generate a second dataset based on the relationship instance and the determination that the resource is able to be transferred to the third entity, cause the portion of the resource to be transferred to the third entity, perform other actions related to the resource and relationship instance, or some combination thereof.

The present disclosure provides systems, computer-readable media, and methods that solve these technical problems by increasing the speed, efficiency and accuracy of such specialized software platforms and computer networks, thus improving the technology of software applications, such as in ERP and accounting software applications. By providing a system that determines classification codes for items with minimal to no input from subject-matter experts, computing devices used by subject-matter experts to determine classification codes are able to conserve processing power, memory, network resources, and other computing resources. For example, using an Online Software Platform to determine a classification code via the system described herein instead of transmitting information to a subject-matter expert and receiving a classification code back from the expert conserves bandwidth and other networking resources for the Online Software Platform and for computer systems operated by the subject-matter expert, and may also conserve processing power, memory, and other computing resources related to displaying the information to the subject-matter expert. In some cases, using the system described herein may also eliminate the need for a subject-matter expert to identify classification codes for new items that may be subject to a relationship instance associated with a primary entity in the future, thus eliminating the computing resources needed by subject-matter experts to identify classification codes for new items. Additionally, by reducing the amount of time needed to determine and apply classification codes, the system is able to more quickly determine digital rules related to the relationship instance. Furthermore, reducing the amount of time needed to determine and apply classification codes to digital rules related to the relationship instance enables the Online Service Platform to determine whether a portion of a resource associated with a relationship instance is able to be transferred to a third entity, which is a function conventional systems are unable to perform until classification codes are identified by a subject-matter expert. As shown above and in more detail throughout the present disclosure, the present disclosure provides technical improvements in computer networks to existing computerized systems to provide accurate and timely classification codes for relationship instances that involve entities that are located in the same domain, different domains, or some combination thereof.

These and other features and advantages of the claimed invention will become more readily apparent in view of the embodiments described and illustrated in this specification, namely in this written specification and the associated drawings.

### BRIEF DESCRIPTION OF THE DRAWINGS

FIG. 1 is a diagram showing sample aspects of embodiments.

FIG. 2 is a diagram showing details and aspects of different types of possible embodiments of the digital resource rules of FIG. 1.

FIG. 3 is a diagram of sample aspects of a primary entity, according to various embodiments described herein.

FIG. 4 is a diagram of sample aspects of an online software platform, according to various embodiments described herein.

FIG. 5 is a diagram of sample aspects of an item classification engine, according to various embodiments described herein.

FIG. 6 is a flowchart for illustrating a first sample method for classifying an item based on data derived from item-sensed data related to a potential relationship instance, according to various embodiments described herein.

FIG. 7 is a flowchart for illustrating a first sample method for generating a refined classification of an item, according to various embodiments described herein.

FIG. 8 is a flowchart for illustrating a sample method for determining whether a resource is able to be transferred to a third entity as a result of the relationship instance, according to various embodiments described herein.

FIG. 9 is a flowchart for illustrating a second sample method for generating refined classification of an item, according to various embodiments described herein.

FIG. 10 is a flowchart for illustrating a sample method for classifying an item based on data derived from a dataset that includes an initial classification of the item, according to various embodiments described herein.

FIG. 11A is a flowchart for illustrating a sample method for training a first classification machine learning model, according to various embodiments described herein.

FIG. 11B is a flowchart for illustrating a sample method for training a second classification machine learning model, according to various embodiments described herein.

FIG. 12 is a hardware diagram that shows details for a sample computer system and for a sample computer system.

FIG. 13 is a diagram for an operational example where a buy-sell transaction is a use case of the relationship instance.

FIG. 14 is a flowchart for illustrating a sample method for receiving data derived from item-sensed data related to a transaction to classify an item included in the transaction, according to various embodiments described herein.

FIG. 15 is a flowchart for illustrating a sample method for generating a refined classification for an item in a transaction, according to various embodiments described herein.

FIG. 16 is a flowchart for illustrating a sample method for determining whether a portion of a resource associated with a transaction is able to be transferred to a third entity, according to various embodiments described herein.

FIG. 17 is a flowchart for illustrating a sample method for classifying an item associated with a transaction based on data derived from a dataset that includes an initial classification of the item, according to various embodiments described herein.

FIG. 18A is a display diagram showing sample view of a first User Interface, shown on a screen, according to various embodiments described herein.

FIG. 18B is a display diagram showing sample view of a second User Interface, shown on a screen, according to various embodiments described herein.

FIG. 18C is a display diagram showing sample view of a third User Interface, shown on a screen, according to various embodiments described herein.

FIG. 19 is a display diagram showing sample view of a fourth User Interface, shown on a screen, according to various embodiments described herein.

### DETAILED DESCRIPTION

As has been mentioned, the present description is about computer systems, storage media that may store programs, and methods. Embodiments are now described in more detail.

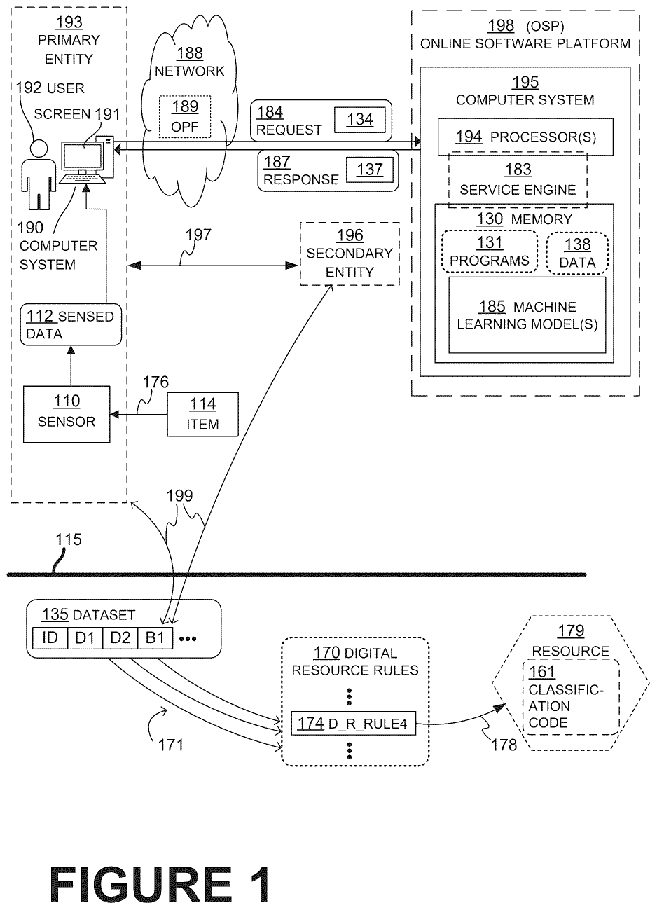

FIG. 1 is a diagram showing sample aspects of embodiments. A thick horizontal line 115 separates this diagram, although not completely or rigorously, into a top portion and a bottom portion. Above the line 115 are shown elements with emphasis mostly on entities, components, their relationships, and their interactions, while below the line 115 are shown elements with emphasis mostly on processing of data that takes place often within one or more of the components that are above the line 115.

Above the line 115, a sample computer system 195 according to embodiments is shown. The computer system 195 has one or more processors 194 and a memory 130. The memory 130 stores programs 131, data 138, and one or more machine learning models 185. The one or more processors 194 and the memory 130 of the computer system 195 thus implement a service engine 183.

The computer system 195 can be located in “the cloud.” In fact, the computer system 195 may optionally be implemented as part of an Online Software Platform (OSP) 198. The OSP 198 can be configured to perform one or more predefined services, for example via operations of the service engine 183. Such services can be searches, determinations, computations, verifications, notifications, the transmission of specialized information, including data that effectuates payments, the generation and transmission of documents, the online accessing of other systems to effect registrations, and so on, including what is described in this document. Such services can be provided in the form of Software as a Service (SaaS). As such, the OSP 198 can be an online service provider.

The user 192 may represent a single user or multiple users. The user 192 may use a computer system 190 that has a screen 191, on which User Interfaces (UIs) may be shown. In embodiments, the user 192 and the computer system 190 are considered part of a primary entity 193. In such instances, the user 192 can be an agent of the primary entity 193, and even within a physical site of the entity 193, although that is not necessary. In embodiments, the computer system 190 or other device of the user 192 can be client devices for the computer system 195. The user 192 or the primary entity 193 can be clients for the OSP 198. For instance, the user 192 may log into the computer system 195 by using credentials, such as a user name, a password, a token, and so on.

The computer system 190 may access the computer system 195 via a communications network 188, such as the Internet. In particular, the entities and associated systems of FIG. 1 may communicate via physical and logical channels of the communication network 188. For example, information may be communicated as data using the Internet Protocol (IP) suite over a packet-switched network such as the Internet or other packet-switched network, which may be included as part of the communication network 188. The communication network 188 may include many different types of computer networks and communication media, including those used by various different physical and logical channels of communication, now known or later developed. Non-limiting media and communication channel examples include one or more, or any operable combination of: fiber optic systems, satellite systems, cable systems, microwave systems, Asynchronous Transfer Mode (“ATM”) systems, frame relay systems, Digital Subscriber Line (“DSL”) systems, Radio Frequency (“RF”) systems, telephone systems, cellular systems, other wireless systems, and the Internet. In various embodiments the communication network 188 can be or include any type of network, such as a Local Area Network (LAN), a Metropolitan Area Network (MAN), a Wide Area Network (WAN), or the Internet. Accordingly, from certain perspectives, the OSP 198 is in the cloud, and is therefore depicted in FIG. 1 within the communication network 188.

The computer system 190 may receive sensed data 112 from a sensor 110. The sensor 110 may be a barcode reader, RFID reader, camera, QR code reader, infrared sensor, depth-mapping sensor, or any other type of sensor or group of sensors that are usable to sense an item, and may be incorporated in a device of any type. The sensor 110 may be used to sense an item, such as the item 114 as indicated by the connector 176. The sensor 110 transmits sensed data received by sensing the item, such as sensed data 112, to the computer system 190. Although a single sensor 110 is shown in FIG. 1, embodiments are not so limited, and the primary entity 193 may be associated with multiple sensors that are each able to obtain sensed data regarding items. Additionally, in some embodiments, the computer system 190 is a mobile device, tablet, or any portable device capable of communicating, interacting and exchanging data with the sensor 110 and with the OSP 198. The computer system 190 may be a single device or multiple devices, which may be a combination of different types of devices.

Accessing, downloading and/or uploading, and so on may be permitted among these computer systems. Such can be performed, for instance, with manually uploading files, like spreadsheet files, etc. Such can also be performed automatically as shown in the example of FIG. 1, with systems exchanging requests and responses.

Moreover, in some embodiments, data from the computer system 190 and/or from the computer system 195 may be stored in an Online Processing Facility (OPF) 189 that can run software applications, perform operations, and so on. In such embodiments, requests and responses may be exchanged with the OPF 189, downloading or uploading may involve the OPF 189, and so on. In such embodiments, the computer system 190 and any devices of the OPF 189 can be considered to be remote devices, at least from the perspective of the computer system 195.

In some instances, the user 192 and/or the primary entity 193 have instances of relationships with secondary entities. Only one such secondary entity 196 is shown, for illustration purposes, however there can be more than one secondary entity. In this example, the primary entity 193 has a relationship instance 197 with the secondary entity 196.

In some instances, the user 192 and/or the primary entity 193 obtain data about one or more secondary entities, for example as necessary for conducting the relationship instances with them. The primary entity 193 and/or the secondary entity 196 may be referred to as simply entities. One of these entities may have one or more attributes. Such an attribute of such an entity may be any one of its name, type of entity, a physical or geographical location such as an address, a contact information element, an affiliation, a characterization of another entity, a characterization by another entity, an association or relationship with another entity (general or specific instances), an asset of the entity, a declaration by or on behalf of the entity, a specific domain that the entity belongs in a context of multiple domains that are defined in terms of the above, and so on.

In embodiments, the computer system 195 receives one or more datasets. A sample received dataset 135 is shown below the line 115. The dataset 135 may be received by the computer system 195 in a number of ways. In some embodiments, one or more requests containing the dataset may be received by the computer system 195 via a network. In this example, a request 184 is received by the computer system 195 via the network 188. The request 184 has been transmitted by the remote computer system 190. The received one or more requests can carry payloads. In this example, the request 184 carries a payload 134. In such embodiments, the one or more payloads may be parsed by the computer system 195 to extract the dataset. In this example, the payload 134 can be parsed by the computer system 195 to extract the dataset 135. In this example the single payload 134 encodes the entire dataset 135, but that is not required. In fact, a dataset can be received from the payloads of multiple requests. In such cases, a single payload may encode only a portion of the dataset. And, of course, the payload of a single request may encode multiple datasets. Additional computers may be involved with the network 188, some beyond the control of the user 192 or OSP 198, and some within such control.

The dataset 135 has values that can also be called dataset values. The dataset values can be numerical, alphanumeric, Boolean, and so on, as needed for what the values characterize. For example, an identity value ID may indicate an identity of the dataset 135, so as to differentiate it from other such datasets. At least one of the dataset values may characterize an attribute of a certain one of the entities 193 and 196, as indicated by correspondence arrows 199. For instance, a value D1 may be the name of the certain entity, a value D2 may be for relevant data of the entity, and so on. Plus, an optional value B1 may be a numerical base value. The database value B1 can be for an aspect of the dataset, and so on. The aspect of the dataset may be the aspect of a value that characterizes the attribute, an aspect of the reason that the dataset was created in the first place, and so on. The dataset 135 may further have additional dataset values, as indicated by the horizontal ellipses in the right side of the dataset 135. (Each time, the ellipses suggest possibly more of what it follows.) In some embodiments, the dataset 135 has values that characterize attributes of both the primary entity 193 and the secondary entity 196, but that is not required. In some embodiments, the dataset 135 has values that indicate the attributes of an item, such as the item 114. The values that indicate the attributes of an item may be determined based on item-sensed data, such as the sensed data 112 received by the computer system 190 from the sensor 110.

In embodiments, digital resource rules 170 are provided for use by the OSP 198. In the example of this diagram, only one sample digital resource rule is shown explicitly, namely rule D_R_RULE4 174. All other such rules are indicated by the vertical ellipses. These rules 170 are digital in that they are implemented for use by software. For example, these rules 170 may be implemented within programs 131, data 138, and machine learning model(s) 185. The data portion of these rules 170 may alternately be stored in memories, local or in other places that can be accessed by the computer system 195. The storing can be in the form of a spreadsheet, a database, etc.

In embodiments, the computer system 195 may access the stored digital resource rules 170. This accessing may be performed responsive to the computer system 195 receiving a dataset, such as the dataset 135. For example, the computer system 195 may access the stored digital resource rules 170 to determine a classification or classification code for an item, such as the classification code 161 and item 114 respectively. In another example, the computer system 195 may access the stored digital resource rules 170 to generate data regarding the proposed relationship instance 197 based on a classification code, such as the classification code 161, determined for an item.

The computer system 195 may select a certain one of the accessed digital resource rules 170. In this example, the rule D_R_RULE4 174 is thus selected as the certain digital resource rule. The selection of this particular rule is indicated also by the fact that an arrow 178 begins from that rule. The arrow 178 is described in more detail later in this document. The computer system 195 may thus select the certain rule D_R_RULE4 174 responsive to one or more of the dataset values of the dataset 135. The impact of the dataset 135 in the selection is indicated by at least some of the arrows 171.

The computer system 195 may produce a resource for the dataset 135, such as the resource 179. The computer system 195 may thus produce the resource by applying the certain digital resource rule, which was previously selected, to at least one of the dataset values of the dataset 135. In the example of FIG. 1, the resource 179 is produced for the dataset 135 by the computer system 195 applying the certain digital resource rule D_R_RULE4 174, as indicated by the arrow 178. The impact of the dataset 135 in producing the resource 179 is indicated by at least one of the arrows 171. The resource 179 may include a classification code 161. The classification code 161 may be determined as part of producing a resource, such as the resource 179. Furthermore, the classification code 161 represents a classification of an item indicated in the dataset 135. In some embodiments, a classification code is used by the computer system 195 to produce the resource 179.

The produced resource can be a document, a determination, a computational result, etc., made, created or prepared for the user 192, and/or the primary entity 193, and/or the secondary entity 196, etc. As such, in some embodiments, the resource is produced by processing and/or a computation. In some embodiments, therefore, the resource is produced on the basis of a characterized attribute of the primary entity 193 and/or the secondary entity 196. In some embodiments, the resource is produced on the basis of the item 114 or one or more aspects of a combination of items represented by the item 114, and at least one characterized attribute of the primary entity 193 and/or the secondary entity 196.

The resource may be produced in a number of ways. For instance, at least one of the dataset values of the dataset 135 can be a numerical base value, e.g., B1, as mentioned above. In such cases, applying the certain digital resource rule may include performing a mathematical operation on the base value B1. For example, applying the certain digital resource rule may include multiplying the numerical base value B1 with a number indicated by the certain digital resource rule. Such a number can be, for example, a percentage, e.g., 1.5%, 3%, 5%, and so on. Such a number can be indicated directly by the certain rule, or be stored in a place indicated by the certain rule, or by the dataset 135, and so on.

In some embodiments, two or more digital main rules may be applied to produce the resource. For example, the computer system 195 may select, responsive to one or more of the dataset values, another one of the accessed digital resource rules 170. These one or more dataset values can be the same as, or different than, the one or more dataset values responsive to which the first selected rule was selected. In such embodiments, the resource can be produced by the computer system 195 also applying the other selected digital resource rule to at least one of the dataset values. For instance, where the base value B1 is used, applying the first selected rule may include multiplying the numerical base value B1 with a first number indicated by the first selected rule, so as to compute a first product. In addition, applying the second selected rule may include multiplying the numerical base value B1 with a second number indicated by the second selected rule, so as to compute a second product. And, a value of the resource may be produced by summing the first product and the second product.

In some embodiments, the classification code 161 is determined by applying one or more machine learning models, such as the machine learning model(s) 185, to one or more values of the dataset. The machine learning model(s) 185 may output one or more classification codes which are applied to one or more digital rules to determine a resultant classification code, such as the classification code 161.

As seen above, the computer system 190, the computer system 195, and possibly also the OPF 189 may exchange requests and responses. Such can be implemented with a number of different architectures. Two examples are now described with reference to the computer systems 190 and 195 only.

In one such architecture, a device remote to the service engine 183, such as the computer system 190, may have a certain application (not shown) and a connector (not shown) that is a plugin that sits on top of that certain application. The computer system 190 via the connector may be able to fetch from the remote device the details required for the service desired from the OSP 198, form an object or payload (e.g. 134), and then send or push a request (e.g. 184) that carries the payload to the service engine 183 via a service call. The service engine 183 may receive the request with its payload. The service engine 183 may then access the digital resource rules 170, find the appropriate one(s) of them, and apply it or them to the payload to produce the requested resource 179. The service engine 183 may then form a payload (e.g., 137) that includes an aspect of the resource 179, and then push, send, or otherwise cause to be transmitted a response (e.g. 187) that carries the payload it formed to the connector. The computer system 190 via the connector receives the response, reads its payload, and forwards that payload to the certain application.

An alternative such architecture uses Representational State Transfer (REST) Application Programming Interfaces (APIs). REST or RESTful API design is designed to take advantage of existing protocols. While REST can be used over nearly any protocol, it usually takes advantage of Hyper Text Transfer Protocol (HTTP) when used for Web APIs. In such an alternative architecture, a device remote to the service engine 183, such as the computer system 190, may have a particular application (not shown). In addition, the computer system 195 implements a REST API (not shown). This alternative architecture enables the primary entity 193 to directly consume a REST API from their particular application, without using a connector. The particular application of the remote device may be able to fetch internally from the remote device the details required for the service desired from the OSP 198, and thus send or push the request 184 to the REST API. In turn, the REST API talks in the background to the service engine 183. Again, the service engine 183 determines the requested resource 179, and sends an aspect of it back to the REST API. In turn, the REST API sends the response 187 that has the payload 137 to the particular application.

Referring again to the digital resource rules 170, digital rules in embodiments can be expressed in the form of a logical “if-then” statement, such as: “if P then Q”. In such statements, the “if” part, represented by the “P”, is called the condition, and the “then” part, represented by the “Q”, is called the consequent. In a set of digital rules, the condition or the consequent may be repeated. For instance, the condition can be the same for multiple different rules. And the consequent can be the same for multiple different rules.

Searching for a rule that applies can be performed by searching for whether or not the rule's one or more conditions are met. The computer system may recognize that such a condition is met. For instance, the certain condition could define a boundary of a region that is within a space. The region could be geometric, and be within a larger space. The region could be geographic, within the space of a city, a state, a country, a continent or the earth. The boundary of the region could be defined in terms of numbers according to a coordinate system within the space. In the example of geography, the boundary could be defined in terms of groups of longitude and latitude coordinates. For instance, the attribute could be a location of the entity, and the one or more values of the dataset 135 that characterize the location could be one or more numbers or an address, or longitude and latitude. A condition can be met depending on how the one or more values compare with the boundary. For example, the comparison may reveal that the location is in the region instead of outside the region. The comparison can be made by rendering the characterized attribute in units comparable to those of the boundary. For example, the characterized attribute could be an address that is rendered into longitude and latitude coordinates, and so on.

The search can be iterative through all the digital rules of a set of rules or of a subset of rules. Sometimes once the condition of one rule is met, its consequent is applied, and the search effectively stops. Other times, all eligible rules are searched, and those whose conditions are met are marked for later consideration and application, for instance by proper implementation of the consequent.

The digital resource rules 170 includes the rule D_R_RULE4 174 that is eventually selected and applied. In some embodiments, the rules 170 are implemented by simple rules. A simple rule has a single condition (“P”), and a single consequent (“Q”). As a result of an initial search, then, the digital resource rule D_R_RULE4 174 is selected, and then its consequent is applied to produce the resource.

In some embodiments, the rules 170 further include additional digital resource rules that select that digital resource rule D_R_RULE4 174 in the first place, for ultimately applying it. In such embodiments, the rules 170 can be implemented as simple rules or as complex rules. Complex rules may have more than conditions, and/or more than one consequents. Complex rules may be implemented as individual single rules with complex coding. Alternatively, a complex rule may be implemented in part by more than one simpler individual rules, which can have hierarchical relationships among them, e.g., from one rule's application or execution leading to another, and so on. As a result of the initial search, then, rules are found which, when applied, select that certain rule in the first place.

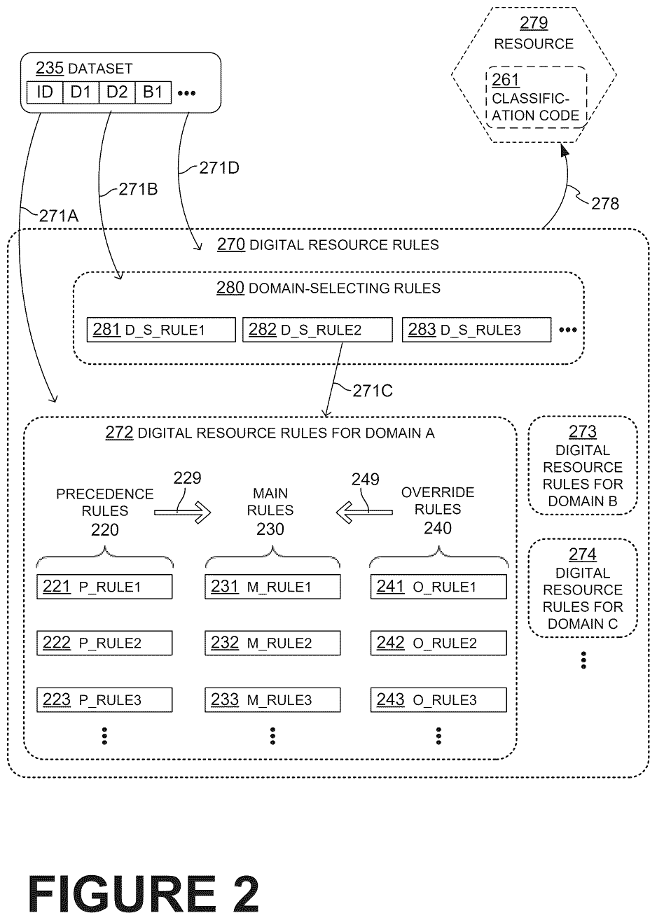

Referring now to FIG. 2, a dataset 235 may be similar to the dataset 135 of FIG. 1. In addition, a set 270 of digital resource rules is an example of digital resource rules, such as the digital resource rules 170 of FIG. 1. Similarly with FIG. 1, in FIG. 2 a resource 279 can be produced according to an arrow 278. The resource 279 may be similar to the resource 179, at least an aspect of which can be reported by the notification 136, and so on. Additionally, a classification code 261 can be produced similar to the classification code 161.

The set 270 of digital resource rules includes different subsets, to which the individual rules belong. In addition, there are hierarchical relationships among rules of different subsets, and/or of types. One of these individual rules is eventually selected and applied, while one or more of them may have been used for selecting it. That certain rule that is eventually selected is not pointed out in FIG. 2, as it was pointed out in FIG. 1, so as to not suggest that that certain rule necessarily belongs in any particular subset. In fact, that certain rule can be in any one of subsets of the digital resource rules 270.

In the example of FIG. 2, the set 270 includes a subset of domain-selecting rules 280. The set 270 also includes subsets 272, 273, and 274 each for digital resource rules for domains A, B, and C respectively. A domain for which a subset of resource rules is thus provided could be associated with the primary entity 193 of FIG. 1, another domain could be associated with the secondary entity 196, and so on.

In many embodiments, one of the domain-selecting rules of the subset 280 can be used to select which domain's rules should be applied. Then the certain one of the digital resource rule(s) can be selected from the digital resource rules of the selected domain. Then the resource 279 can be produced by applying the selected certain digital resource rule(s) to at least one of the dataset values of the dataset 235.

In this example, the subset of domain-selecting rules 280 includes rules D_S_RULE1 281, D_S_RULE2 282, and D_S_RULE3 283. One of these rules may be selected and used when more than one domain could be considered as eligible for its rules to apply. The rules of the subset 280, however, might not be necessary for embodiments where a single domain is considered or implied for one or more, or all of, the relationship instances. This can happen, for example, when it is known in advance that the primary entity 193 and every possible secondary entity are both associated with the same domain. Or, when it is planned that digital resource rules of only one domain will be considered, while any rules of any other domain will not be considered and will be disregarded.

Resource rules for individual domains are now described. Such rules need not be the same for each domain, or of the same type for each domain. The sample subset 272 of resource rules for domain A is now described in more detail. Its description can be similar for subsets for other domains, such as the subsets 273 and 274.

The subset 272 of resource rules includes different types of rules. In this example, the subset 272 includes precedence rules 220, main rules 230, and override rules 240. In this example, the precedence rules 220 include rules P_RULE1 221, P_RULE2 222, and P_RULE3 223. The main rules 230 include rules M_RULE1 231, M_RULE2 232, and M_RULE3 233. The override rules 240 include rules O_RULE1 241, O_RULE2 242, and O_RULE3 243. Any of the precedence rules 220, main rules 230, and override rules 240 may be used in a determination of a classification code, such as the classification code 261. Furthermore, a classification code, such as the classification code 261, may affect which of the precedence rules 220, main rules 230, and override rules 240 are applied to a relationship instance involving two or more domains.

In embodiments, one of the main rules 230 may ordinarily be selected as the certain digital resource rule, which in FIG. 1 is shown as rule D_R_RULE4 174. In other words, the certain digital resource rule could be, say, the main rule M_RULE2 232. In this example, although not always required, the different types of rules within the subset 272 further have different hierarchies among them.

For a first instance, one of the precedence rules 220 may indicate which one of the main rules 230 is to be selected, as generally indicated by an arrow 229. Or, the one of the precedence rules 220 that does apply may itself be the eventually selected certain digital resource rule, instead of indicating any one of the main rules 230.

For a second instance, even when one of the main rules 230 is thus indicated, one of the override rules 240 may still override the indication, as generally indicated by an arrow 249. In such cases, the one of the rules 240 that overrides may be the eventually selected certain digital resource rule, instead of one of the main rules 230. Or, one of the rules 240 overrides by indicating yet a different one of the main rules 230 to be selected instead, and so on.

In FIG. 2, sample arrows 271A, 271B and 271D begin from the dataset 235. These arrows suggest possible paths of the eventual selection of the certain rule, for ultimately producing the resource 279. These arrows are more detailed versions of the arrows 171 of FIG. 1. They are examples of possible arrows, and not all of them are necessarily used in every such determination.

According to the arrow 271A, the subset 272 is indicated. So, at least one of the rules of the subset 272 may initially be indicated as the certain rule, e.g., from one or more values of the dataset 235. The initially indicated rule can be the finally certain rule, or another intermediate rule which, in turn, will be used to select that certain rule.

According to the arrow 271B, at least one of the domain-selecting rules of the subset 280 may be invoked, from one or more values of the dataset 235.

According to an arrow 271C, the one of the rules of subset 280 that was invoked by the arrow 271B was the rule D_S_RULE2 282. And, the arrow 271C further indicates that the invoked rule points to the subset 272, instead of to the subsets 273 and 274. As such, the subset 272 of resource rules should be used for selecting the certain rule. This example has the same result, but from a different path, as the sample arrow 271A.

The arrow 271D is drawn to indicate that one or more of the values of the dataset 235 are received and processed by the finally selected certain rule, for producing the resource 279.

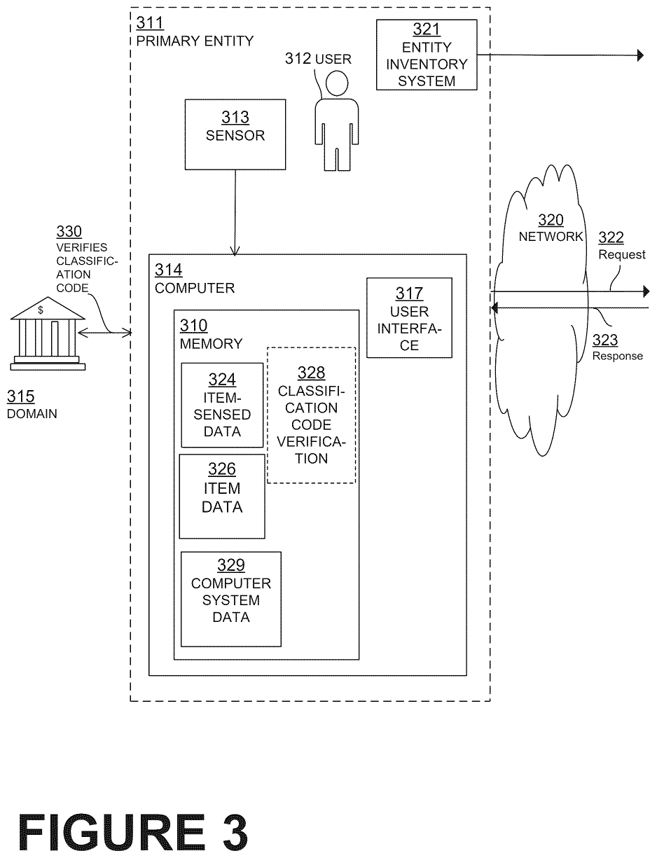

FIG. 3 is a diagram of sample aspects of a primary entity 311, according to various embodiments described herein. The primary entity 311 is similar to the primary entity 193, described above in connection with FIG. 1. The primary entity 311 includes a user 312, a computer 314, a sensor 313, and an entity inventory system 321. The user 312, the sensor 313 and the computer 314 may be similar to the user 192, sensor 110, and computer system 110, respectively. The entity inventory system 321 may be a computer system that stores item data for items, such as the item data 326, associated with the entity, such as, for example, a database system.

Furthermore, the primary entity 311 may utilize a network 320 to transmit requests, such as the request 322, and to receive responses, such as the response 323. The network 320, request 322, and response 323, are similar to the network 188, request 184, and response 187, respectively. Thus, the primary entity 311 may communicate with an OSP, such as the OSP 198, via the network 320.

The primary entity 311 may interact with a domain 315, as indicated by the connector 330. The primary entity 311 may interact with the domain 315, such as through a network, to verify one or more classification codes as indicated by the connector 330.

The computer 314 includes memory 310 and a user interface 317. The computer 314 may use the user interface 317 to display information to a user, such as the user 312, receive input from a user, display output to a user, or to perform other functions that allow the user to view or interact with programs or data. For example, in some embodiments, the computer 314 receives one or more prompts from an OSP, such as the OSP 198, displays the prompts to the user 312 via the user interface 317, and receives input regarding the prompts from the user 312 via the user interface 317.

The memory 310 may store programs or data (not shown), such as the programs 131 and data 138 described above in connection with FIG. 1. The memory 310 stores data relevant to the operation of the systems described herein, such as item-sensed data 324 and item data 326.

The item-sensed data 324 may be similar to the sensed data 112 described above in connection with FIG. 1. The computer 314 may receive item-sensed data 324 from a sensor 313.

The item data 326 may include data describing one or more items. The one or more items may be or include: items that are detected or sensed by a computer 314 or sensor 313; items that are included in a repository of items maintained by, accessed by, used by, or otherwise associated with the primary entity 311; or other items. The item data 326 may be or include: data generated from item-sensed data 324; data generated from other item data; data included in a repository of item data maintained by, accessed by, used by, or otherwise associated with the primary entity 311, such as the entity inventory system 321; or other data describing an item.

In some embodiments, the memory 310 additionally stores data related to classification code verification 330. The classification code verification 330 includes instructions, data, programs, etc., used by the computer 314 to verify a classification code with a domain, such as a domain 315. For example, the classification code verification 330 may include data indicating a web portal associated with a domain through which classification code verification requests may be made. In such an example, the computer 314 may receive an indication of a classification code from an OSP, such as the OSP 198, and may then verify the classification code by using the classification code verification 330.

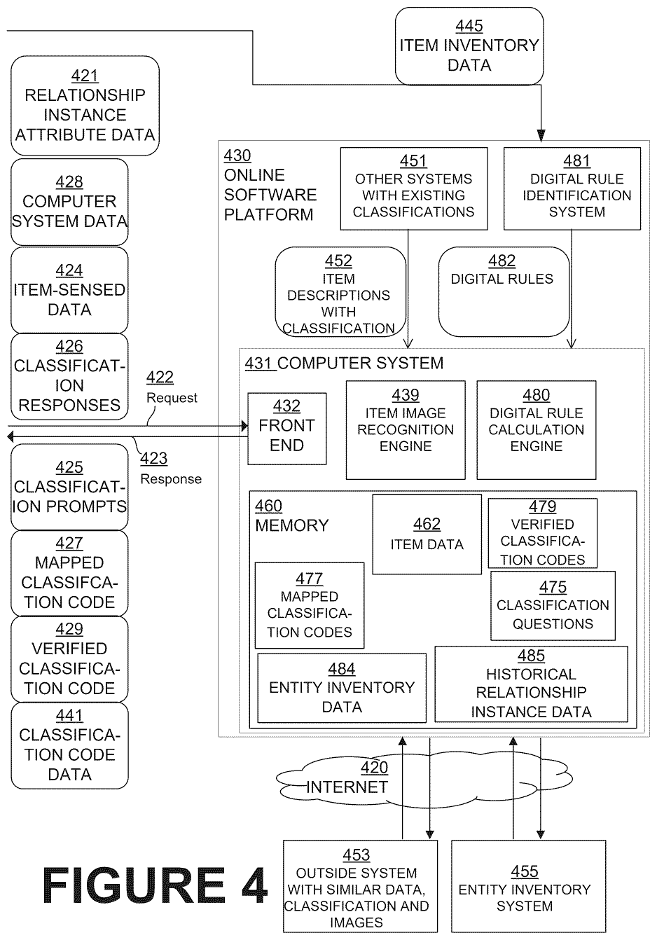

FIG. 4 is a diagram of sample aspects of an online software platform 430, according to various embodiments described herein. The online software platform 430 (“OSP 430”) is similar to the OSP 198, described above in connection with FIG. 1. The OSP 430 includes various systems, such as systems with existing classifications 451 and a computer system 431.

The systems with existing classifications 451 are, or include, other systems associated with the OSP 430, such as repositories of item data, repositories of item classification data, systems used for other types of item classifications, systems associated with one or more entities that have already classified one or more items, or other systems that may use or include item classifications. The OSP 430 may cause one or more of the systems with existing classifications to transmit one or more item descriptions with classifications 452 to the computer system 431. For example, the systems with existing classifications 451 may have already classified an item included in a request to the computer system 431, and the OSP 430 may cause the classification of the item to be transmitted to the computer system 431. In this example, the computer system 431 is able to conserve processing, memory, and other computing resources by using the received classification of the item, such as by using the classification as a starting point to classify the item, using the classification outright, etc.

The computer system 431 includes a front end 432, an item image recognition engine 439, digital rule calculation engine 480, and a memory 460. The computer system 431 is similar to the computer system 195 described above in connection with FIG. 1. The front end 432 may be or include an API or other interface for the computer system 431 to receive or transmit requests and responses from a primary entity, such as the primary entity 193 described above in connection with FIG. 1.

In an example, the computer system 431 receives a request 422 that includes item-sensed data 424. The computer system 431 processes the item-sensed data 424 and determines it needs more information to classify an item indicated by the item-sensed data 424. The computer system 431 transmits a response 423 to the primary entity that includes classification prompts 425 to trigger classification responses 426 from the primary entity in a second request 422. The computer system 431 determines a mapped classification code 427 based on the classification responses and item data, and transmits the mapped classification code 427 to the primary entity.

The computer system 431 may apply one or more digital rules and the mapped classification to a relationship instance indicated in the request 422 by using the digital rule calculation engine 480. The digital rules 482 may be identified by the OSP 430, such as in the manner described above in connection with FIG. 2. The OSP 430 may identify the digital rules 482 via a digital rule identification system 481 that performs one or more of the functions described above in connection with FIG. 2.

The OSP 430 may utilize the Internet 421, or another network, to communicate with one or more of the primary entity, a secondary entity, other outside systems such as the outside system 453, an entity inventory system 455, or some combination thereof. The outside system 453 may be another OSP, a system associated with a primary entity, a system associated with a secondary entity, a system associated with a domain, other systems that may be used to classify items based on classification codes, or other systems that may be used to identify items based on an image. For example, the computer system 431 may verify the classification code with a domain in a process similar to the primary entity 311 verifying a classification code with the domain 315 described above in connection with FIG. 3 to obtain a verified classification code 429. The computer system 431 may verify the classification code with the domain by accessing a system associated with the domain. The verified classification code 429 may be transmitted via the response 423.

The entity inventory system 455 may be the entity inventory system 321, or other entity inventory systems. The entity inventory system 455 include item data, such as the item inventory data 445, or other item inventory data, such as item inventory data from entity inventory systems associated with entities other than the primary entity described above in connection with FIG. 3.

The front end 432 may be a web server, web engine, or other interface that interacts with a browser operated by a client computing device, such as the computer system 190 described above in connection with FIG. 1.

The memory 460 of the computer system 431 includes item data 462, classification questions 475, mapped classification codes 477, verified classification codes 479, item inventory data 484, and historical relationship instance data 485. The item data 462 may be similar to the item data 326. The mapped classification codes 477 include data describing classification codes which have been mapped to items by classifying the items. The verified classification codes 479 include data describing classification codes which have been verified with a domain to be mapped to items. The entity inventory data 484 may include inventory data received from one or more entity inventory systems 455. The historical relationship instance data 485 may include data describing one or more relationship instances associated with the primary entity that occurred in the past, such as attributes of the relationship instances, items included in the relationship instances, etc.

The classification questions 475 include one or more questions or prompts that the computer system 431 may transmit to a primary entity. Answers to the classification questions 475 may be used by the computer system 431 to refine a classification for an item and map a classification code to the item based on the classification. In some embodiments, answers to the classification questions 475 may be used as training data for one or more classification artificial intelligence or machine learning models, such as any artificial intelligence or machine learning models included in the image recognition engine 439.

The computer system 431 uses the item image recognition engine 439 as part of determining a classification or classification code for an item, such as by: identifying an item indicated by item-sensed data; determining, generating, synthesizing, or otherwise creating prompts for classifying an item; or accessing or using other processes, data, systems, techniques, etc. for identifying an item or generating a classification or classification code for an identified item. Although the item image recognition engine 439 uses image data included in item-sensed data, such as item-sensed data 424, embodiments are not so limited, and data of other types indicating an item, such as text data, infrared data, sound data, depth-mapping data, or any other data which may describe an item. In some embodiments, the item image recognition engine 439 includes a first classification model and a second classification model. In some embodiments, the first classification model is a computer-vision model. In some embodiments, the second classification model is a Bayesian regression model.

The request 422 received by the OSP 430 may include relationship instance attribute data 421, computer system data 428, item-sensed data 424, classification responses 426, or some combination thereof. The relationship instance attribute data 421 may include data indicating one or more attributes of a relationship instance for which the request 422 was transmitted to the OSP 430. The computer system data 428 may include data describing a computer system associated with a primary entity, such as the primary entity described above in connection with 430. The item-sensed data 424 may include data similar to the item-sensed data 324 described above in connection with FIG. 3. The classification responses 426 may include data indicating one or more responses to classification prompts generated based on the classification questions 475.

The response 423 may include classification prompts 425, a mapped classification code 427, a verified classification code 429, classification code data 441, or some combination thereof. The classification prompts 425 may be generated by the OSP 430 based on the classification questions 475. The mapped classification code 427 may be a final, or “refined,” classification code of an item associated with a relationship instance. The verified classification code 429 may be a refined classification code of an item that was verified by the OSP 430 by interacting with one or more other systems, such as systems of one or more primary entities, systems associated with a domain, etc. The classification code data 441 may include data indicating one or more probabilities that an item is to be classified by using one or more classification codes. For example, the classification code data 441 may indicate that an item is ninety percent likely to be a hammer and ten percent likely to be a mallet.

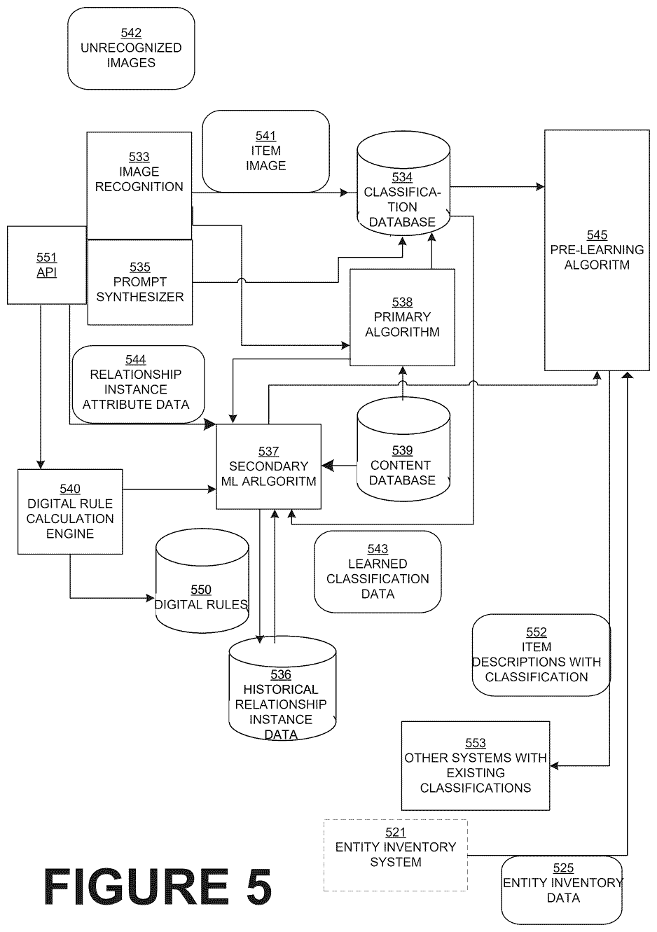

FIG. 5 is a diagram of sample aspects of an item recognition engine 529, according to various embodiments described herein. The item image recognition engine 529 may be the item recognition engine 429 described above in connection with FIG. 4. The item image recognition engine 529 includes an API 551 which may be used by an OSP, such as the OSP 430, a computer system, such as the computer system 431, or other processes or systems which may be used to determine a classification or classification code for an item.

The API 551 passes data, such as item-sensed data, to and receives data, such as item identity data or item classification data, from an image recognition process 533. The image recognition process 533 applies the item-sensed data to an image recognition algorithm, such as an artificial intelligence or machine learning model, to identify an item in the item-sensed data and generate an initial classification of the item. The image recognition process 533 may pass an identified item image 541 or an unrecognized item image 542 to the item classification algorithm 538. Data associated with the identity of the item is passed from the image recognition process 533 to the item classification algorithm 538. In some embodiments, the image recognition algorithm 533 may be improved or re-trained based on classified images stored in the classification database 534. In some embodiments, the image recognition process 533 uses a computer-vision model to generate the initial classification of the item.

The item classification algorithm 538 classifies an item based on item identity data, such as item identity data received from the image recognition process 533. The item classification algorithm 538 may receive data from a classification database 534 related to previous item classifications. The item classification algorithm 538 may transmit data regarding the classification of the item and the identity of the item to a content database 539. In some embodiments, one or more aspects of the image recognition process 533 and item classification algorithm 538 are performed by a first classification machine learning model, such as, for example, a computer-vision model. In some embodiments, one or more aspects of the item classification algorithm 538 and image recognition algorithm 533 are performed by a computer system of a primary entity, such as the computer system 190 described above in connection with FIG. 1.

The item classification algorithm 538 may transmit the initial classification of the item to a secondary machine learning model algorithm 537 that generates a refined classification of the item. The secondary machine learning model algorithm 537 may use relationship instance attribute data 544 and the initial classification of the item to generate a refined classification of the item. In some embodiments, the secondary machine learning model algorithm 537 additionally uses historical relationship instance data 536 to generate the refined classification of the item. In some embodiments, the secondary machine learning model algorithm 537 additionally uses a classification of one or more other items included in a relationship instance to generate the refined classification. In some embodiments, the secondary machine learning algorithm 537 includes a Bayesian Regression model. The output of the secondary machine learning algorithm 537 is transmitted to a classification code mapping tool, such as the classification code mapping tool 540. The secondary machine learning algorithm 537 transmits learned classification data, such as learned classification data 543 to the classification database 534. Learned classification data includes one or more of: data regarding the classification of an item; data regarding one or more classification codes generated for an item; item identity data; classification data; answers to prompts; or other data related to generating a classification code for an item. In some embodiments, the secondary machine learning algorithm 537 determines whether answers to additional prompts are needed in order to generate a resultant classification code. In such embodiments, the secondary machine learning algorithm 537 receives additional answers to prompts from the API 551.

The content database 539 includes data regarding the classification of items and item identity data regarding the classified items, such as the learned classification data 543. The data included in the content database 539 may be used to re-train or otherwise improve an artificial intelligence or machine learning model used to classify items based on item identity data. In some embodiments, the content database 539 additionally includes data indicating one or more prompts that may be used to classify items.

The API 551 receives data from a prompt synthesizer 535. The prompt synthesizer 535 receives data from the classification database 534 to generate prompts used to determine the identity or classification of an item. The prompt synthesizer 535 transmits prompts to a computer system or OSP by the API 551. The API 551 transmits answers to the prompts to an image and prompts machine learning algorithm, such as the secondary machine learning algorithm 537.

In some embodiments, the digital rule calculation engine 540 maps a classification code to the item based on one or more classification codes received from the secondary machine learning algorithm 537. The digital rule calculation engine 540 may receive data associated with digital rules for classifying items with classification codes from a digital rule database 550. The digital rule database 550 includes data associated with digital rules used to classify items. The digital rule calculation engine 540 transmits the mapped classification code to the API 551.

A pre-learning engine 545 transmits pre-learned data to the classification database 534 and to the secondary machine learning algorithm 537 to assist in the classification and identification of items. The pre-learning engine 545 may receive data from other systems with existing classifications 553, such as item descriptions with classification 552. The other systems with existing classifications 553 may be similar to the other systems with existing classifications 451, described above in connection with FIG. 4. The item descriptions with classification 552 may be similar to the item description with classification 452, described above in connection with FIG. 4. In some embodiments, the pre-learning engine 545 may receive data from one or more entity inventory systems 521, such as entity inventory data 525. The entity inventory systems 521 may be similar to the entity inventory system 455 described above in connection with FIG. 4. The pre-learning engine 545 may use the data received from the other systems with existing classifications 553, entity inventory system 521, or some combination thereof, to train the various algorithms and machine learning models included in the item image recognition engine 529.

In some embodiments, the pre-learning engine 545, for learning purposes, may receive data from within the item image recognition engine 529 or within the OSP 430, for example in consort with the item image recognition engine 529, when relevant data is updated by the image recognition engine 529. In some embodiments, the image recognition process 533 may additionally provide the item image 541 or updated item data and image (e.g., updated item data and images about the unrecognized images 542) to the pre-learning engine 545 directly, or indirectly via one or more other components of the item image recognition engine 529, such as via the item classification algorithm 538, the machine learning algorithm 537, and so on. Updated data (e.g., updated images and/or item data) may also be utilized by the pre-learning engine 545 to train the engine's various algorithms and machine learning models.

In some embodiments, the pre-learning engine 545 may receive data from other outside sources, such as the outside system with similar data, classification and images 453 described above in connection with FIG. 4.

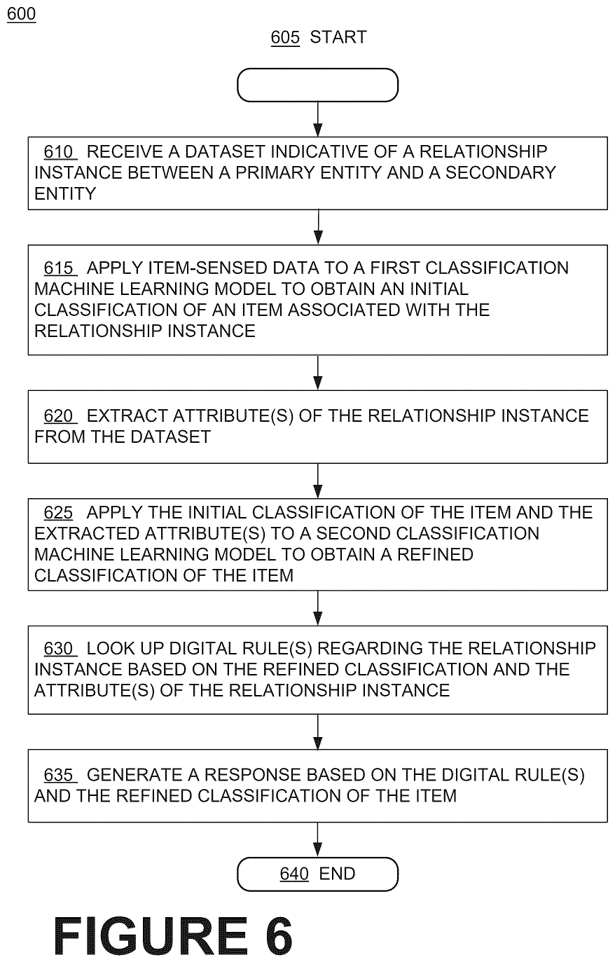

In the present example, the operations and methods described with reference to the flowcharts illustrated in FIGS. 6-11B and 14-17 are described as being performed by the OSP 198 or OSP 1498. Although the operations and methods described with the flowcharts illustrated in FIGS. 6-11B and 14-17 are described as being performed by the computer system 190, computer system 1490, OSP 198 or OSP 1498, embodiments are not so limited, and any of the operations or methods may be performed by any of the computer system 190, computer system 1490, OSP 198 or OSP 1498.

FIG. 6 is a flowchart for illustrating a first sample method 600 for classifying an item based on data derived from item-sensed data related to a potential relationship instance, according to various embodiments described herein.

The method 600 starts at 605.

At 610, the OSP 198 receives a dataset indicative of a relationship instance between a primary entity and a secondary entity, the dataset including item-sensed data. In some embodiments, the item-sensed data may be similar to the item-sensed data 112 described above in connection with FIG. 1.

At 615, the OSP 198 applies item-sensed data to a first classification machine learning model to obtain an initial classification of an item associated with the relationship instance. In some embodiments, the first classification machine learning model is a computer-vision model.

At 620, the OSP 198 extracts one or more attributes of the relationship instance from the dataset. The one or more attributes of the relationship instance may be an entity type of the primary entity, an entity type of the secondary entity, a weight of one or more items associated with the relationship instance, a size of one or more items associated with the relationship instance, a location associated with the relationship instance, a number of items associated with the relationship instance, other attributes of the relationship instance, or some combination thereof. In some embodiments, the OSP 198 extracts one or more attributes of the relationship instance by applying text data included in the dataset to a large language model to identify one or more aspects of the relationship instance. In some embodiments, the attributes of the relationship instance include a textual description of the item. In such embodiments, the textual description of the item may be generated by a large language model that receives textual data included in the dataset, item-sensed data included in the dataset, or some combination thereof, as input.

At 625, the OSP 198 applies the initial classification of the item and the extracted attributes to a second classification machine learning model to obtain a refined classification of the item. In some embodiments, the second classification machine learning model is a Bayesian Regression model.

At 630, the OSP 198 looks up one or more digital rules regarding the relationship instance based on the refined classification of the item and the extracted attributes of the relationship instance.

At 635, the OSP 198 generates a response based on the digital rules and the refined classification of the item.

The method ends at 640.

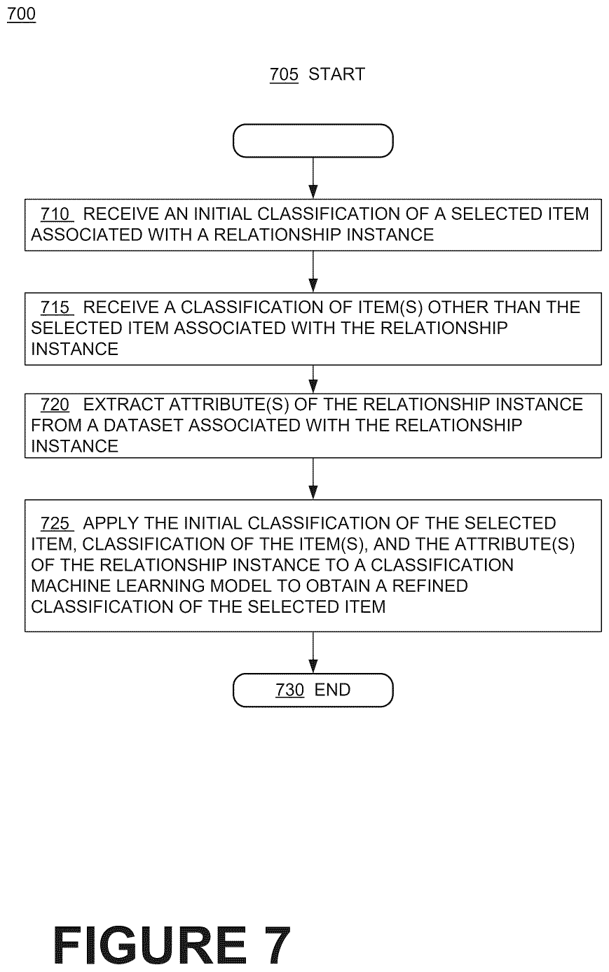

FIG. 7 is a flowchart for illustrating a first sample method 700 for generating a refined classification of an item, according to various embodiments described herein. In some embodiments, the OSP 198 performs the method 700 as part of performing the method 600.

The method 700 starts at 705.

At 710, the OSP 198 receives an initial classification of a selected item associated with a relationship instance. In some embodiments, the selected item is any item associated with the relationship instance. In some embodiments, the selected item is an item for which the probability that the classification of the item is correct is below a threshold amount. For example, if the probability output by a classification model that the item is a hammer is below a threshold of ninety percent, the item may be designated as a selected item. Continuing the example, if the probability output by a classification model that the item is a hammer is greater than or equal to a threshold of ninety percent, the item may not be designated as the selected item.

At 715, the OSP 198 receives a classification of items other than the selected item that are associated with the relationship instance. In some embodiments, the OSP may receive a classification of items for which the probability that the classification of the items is correct has exceeded a threshold amount.

At 720, the OSP 198 extracts attributes of the relationship instance from a dataset associated with the relationship instance.

At 725, the OSP 198 applies the initial classification of the selected item, received classification of the items, and the attributes of the relationship instance to a second classification machine learning model to obtain a refined classification of the selected item. In some embodiments, the OSP 198 performs act 725 in a similar manner to act 625, described above in connection with FIG. 6.

At 730, the method 700 ends.

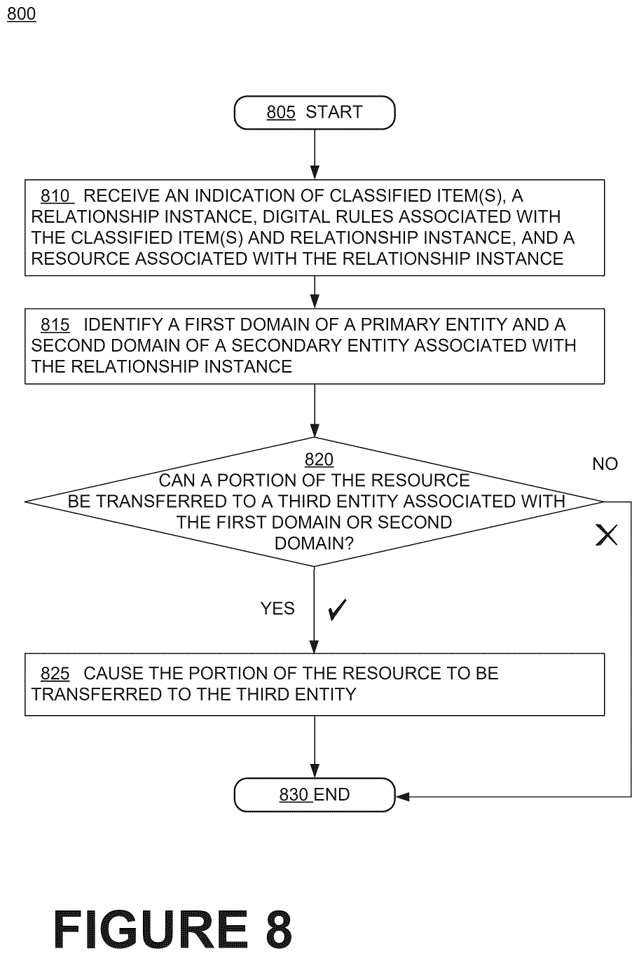

FIG. 8 is a flowchart for illustrating a sample method 800 for determining whether a resource is able to be transferred to a third entity as a result of the relationship instance, according to various embodiments described herein. In some embodiments, the OSP 198 performs the method 800 after performing the method 600.

The method 800 starts at 805.

At 810, the OSP 198 receives an indication of one or more classified items, a relationship instance, digital rules associated with the classified items and relationship instance, and a resource associated with the relationship instance. In some embodiments, the OSP 198 generates the resource associated with the relationship instance based on the digital rules associated with the relationship instance, the classified items, the relationship instance, or some combination thereof.

At 815, the OSP 198 identifies a first domain of a primary entity and a second domain of a secondary entity associated with the relationship instance.

At 820, the OSP 198 determines whether a portion of the resource is able to be transferred to a third entity associated with the first domain, the second domain, or some combination thereof. If the resource is not able to be transferred to a third entity, the method 800 proceeds to 830, otherwise the method proceeds to 825. In some embodiments, the OSP 198 determines whether the portion of the resource is able to be transferred to the third entity based on the refined classification of the one or more items, the digital rules, and the relationship instance.

At 825, the OSP 198 causes the portion of the resource to be transferred to the third entity. In some embodiments, the OSP 198 causes the portion of the resource to be transferred to the third entity by generating data regarding the transfer of the portion of the resource to the third entity based on one or more digital rules, the resource associated with the relationship instance, and the third entity. In some embodiments, the OSP 198 causes the portion of the resource to be transferred to the third entity by automatically initiating a transfer of the portion of the resource to the third entity, such as by transmitting instructions to transfer the portion of the resource to a computing device associated with the primary entity, the third entity, another entity associated with the primary entity, or some combination thereof.

At 830, the method 800 ends.

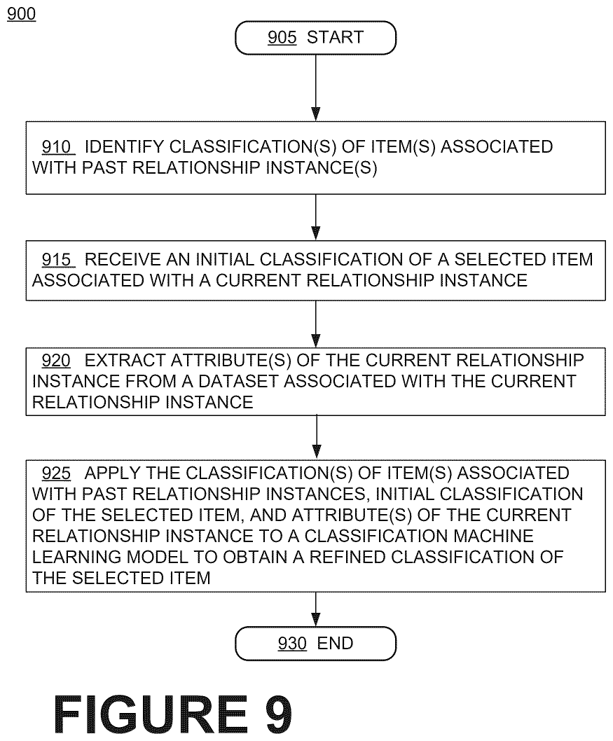

FIG. 9 is a flowchart for illustrating a second sample method 900 for generating refined classification of an item, according to various embodiments described herein. The OSP 198 may perform the method 900 as part of performing the method 600, described above in connection with FIG. 6.

The method 900 starts at 905.

At 910, the OSP 198 identifies one or more classifications of one or more items associated with past relationship instances. In some embodiments, the past relationship instances are past relationship instances associated with the primary entity. In some embodiments, the classifications of one or more items associated with past relationship instances are identified based on an initial classification of one or more items associated with a current relationship instance.

At 915, the OSP 198 receives an initial classification of a selected item associated with a current relationship instance. In some embodiments, the OSP 198 performs act 915 in a similar manner to act 710, described above in connection with FIG. 7.

At 920, the OSP 198 extracts one or more attributes of the current relationship instance form a dataset associated with the current relationship instance. In some embodiments, the OSP 198 performs act 920 in a similar manner to act 620, described above in connection with FIG. 6.

At 925, the OSP 198 applies the classifications of items associated with past relationship instances, initial classification of the selected item, and attributes of the current relationship instance to a classification machine learning model to obtain a refined classification of the selected item. In some embodiments, the OSP 198 additionally applies one or more attributes of past relationship instances to the classification machine learning model to obtain the refined classification of the selected item.

At 930, the method 900 ends.

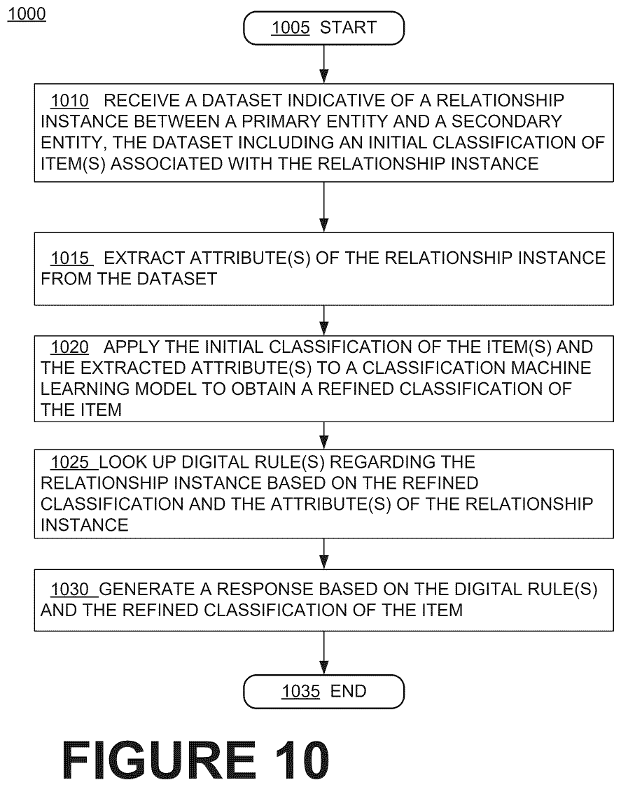

FIG. 10 is a flowchart for illustrating a sample method 1000 for classifying an item based on data derived from a dataset that includes an initial classification of the item, according to various embodiments described herein. In some embodiments, the OSP 198 performs the method 1000 as part of performing the method 600. In such embodiments, the OSP 198 may optionally perform act 615, described above in connection with FIG. 6.

The method 1000 starts at 1005.

At 1010, the OSP 198 receives a dataset indicative of a relationship instance between a primary entity and a secondary entity, the dataset including an initial classification of one or more items associated with the relationship instance. In some embodiments, the initial classification of the one or more items is generated by a computer system associated with the primary entity, such as the computer system 190 described above in connection with FIG. 1.

At 1015, the OSP 198 extracts one or more attributes of the relationship instance from the dataset.

At 1020, the OSP 198 applies the initial classification of the one or more items and the extracted attributes to a classification machine learning model to obtain a refined classification of the item.

At 1025, the OSP 198 looks up one or more digital rules regarding the relationship instance based on the refined classification of the one or more items and the extracted attributes of the relationship instance. In some embodiments, the OSP performs act 1025 in a similar manner to act 630, described above in connection with FIG. 6.

At 1030, the OSP 198 generates a response based on the digital rules and the refined classification of the item. In some embodiments, the OSP 198 performs act 1030 in a similar manner to act 635, described above in connection with FIG. 6.

At 1035, the method 1000 ends.

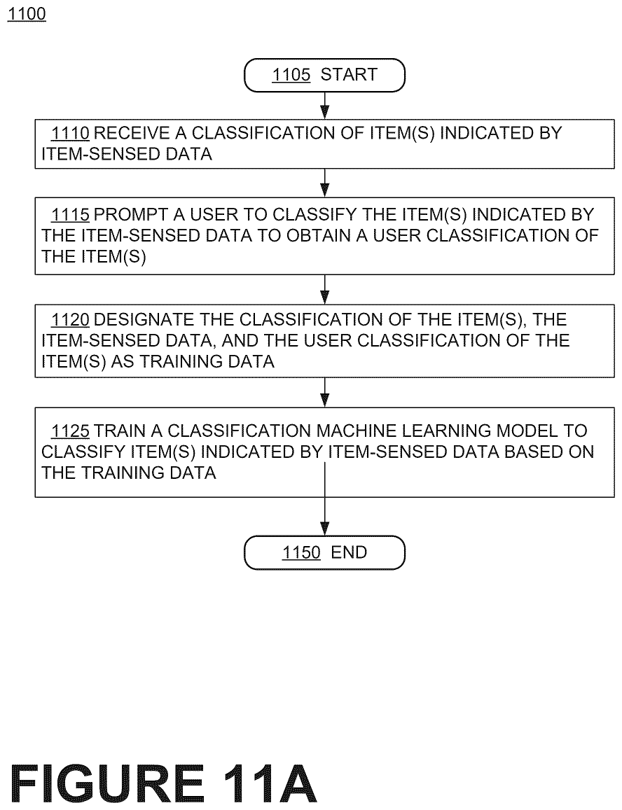

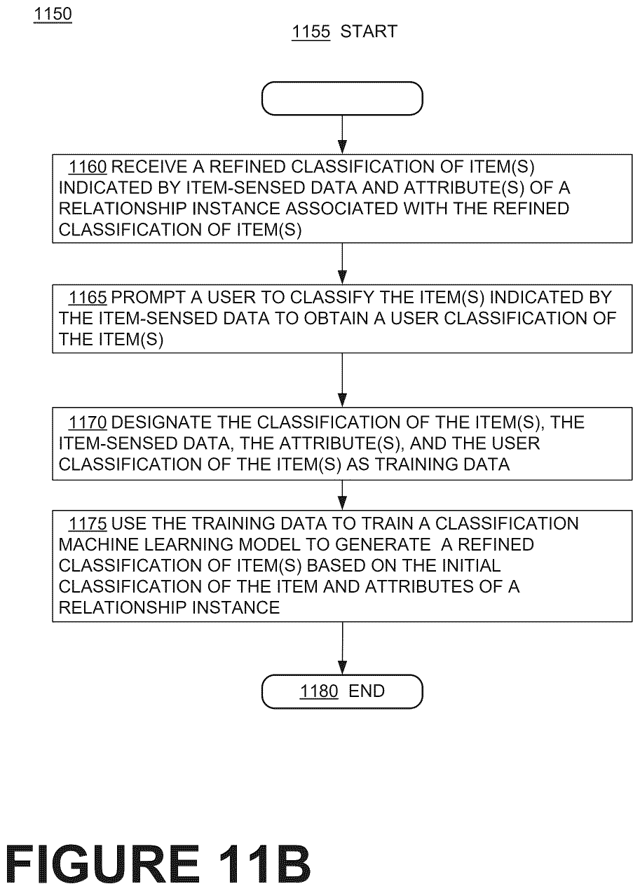

FIG. 11A is a flowchart for illustrating a sample method 1100 for training a first classification machine learning model, according to various embodiments described herein.

The method 1100 starts at 1105.

At 1110, the OSP 198 receives an initial classification of one or more items indicated by item-sensed data. In some embodiments, the OSP 198 receives the initial classification of the one or more items as a result of performing act 615, described above in connection with FIG. 6.

At 1115, the OSP 198 prompts a user to classify the one or more items indicated by the item-sensed data to obtain a user classification of the one or more items. In some embodiments, the OSP 198 generates one or more prompts based on at least one of: one or more attributes of an item, an initial classification for the item, or some combination thereof. In some embodiments, the OSP 198 generates the one or more prompts via a prompt synthesizer, such as the prompt synthesizer 535 described above in connection with FIG. 5. For example, when the machine learning model outputs multiple classification codes for an item, the OSP 198 may determine which information is needed to determine which classification code should be assigned to an item based on the multiple output classification codes. In this example, the OSP 198 generates the one or more prompts based on the information needed to determine which classification code should be assigned to the item. In some embodiments, the one or more prompts are transmitted to a user device associated with the primary entity, such as the computer system 190. In such embodiments, the OSP 198 may receive a response to the one or more prompts from the user device associated with the primary entity.

At 1120, the designates the classification of the one or more items, the item-sensed data, and the user classification of the one or more items as training data.

At 1125, the OSP 198 trains a first classification machine learning model to classify an item indicated by item-sensed data based on the training data. In some embodiments, the first classification machine learning model is a computer-vision model. In some embodiments, the OSP 198 uses the training data to re-train the first classification model.

At 1125 the process 1100 ends.

In some embodiments, the OSP 198 determines whether to perform the process 1100 based on the output of the first classification machine learning model. For example, if a confidence score of the machine learning model's output exceeds a threshold level, the OSP 198 may determine that the process 1100 should be performed to obtain a resultant classification code. In such an example, the resultant classification code may be a classification code that was not output by the machine learning model. In another example, if the machine learning model outputs multiple classification codes which each have confidence scores that exceed a threshold level, the OSP 198 may determine that the process 1100 should be performed to determine which of the multiple classification codes, if any, are the resultant classification code.

FIG. 11B is a flowchart for illustrating a sample method 1150 for training a second classification machine learning model, according to various embodiments described herein.

The method 1150 starts at 1155.

At 1160, the OSP 198 receives a refined classification of one or more items indicated by item-sensed data and one or more attributes of a relationship instance associated with the refined classification of the one or more items. In some embodiments, the OSP 198 recieves the refined classification and attributes of a relationship instance as a result of performing acts 620 and 625, described above in connection with FIG. 6.

At 1165, the OSP 198 prompts a user to classify the one or more items indicated by the item-sensed data to obtain a user classification of the one or more items. In some embodiments, the OSP 198 performs act 1165 in a similar manner to act 1115, described above in connection with FIG. 11A.

At 1170, the OSP 198 designates the classification of the one or more items, the item-sensed data, the one or more attributes, and the user classification of the items as training data.

At 1175, the OSP 198 uses the training data to train a second classification machine learning model to generate a refined classification of an item based on the initial classification of the item and one or more attributes of a relationship instance.

At 1180, the process 1150 ends.

In some embodiments, the OSP 198 determines whether to perform the process 1150 based on the output of the second classification machine learning model. For example, if a confidence score of the machine learning model's output exceeds a threshold level, the OSP 198 may determine that the process 1150 should be performed to obtain a refined classification code. In such an example, the refined classification code may be a classification code that was not output by the machine learning model. In another example, if the machine learning model outputs multiple classification codes which each have confidence scores that exceed a threshold level, the OSP 198 may determine that the process 1100 should be performed to determine which of the multiple classification codes, if any, are the refined classification code.

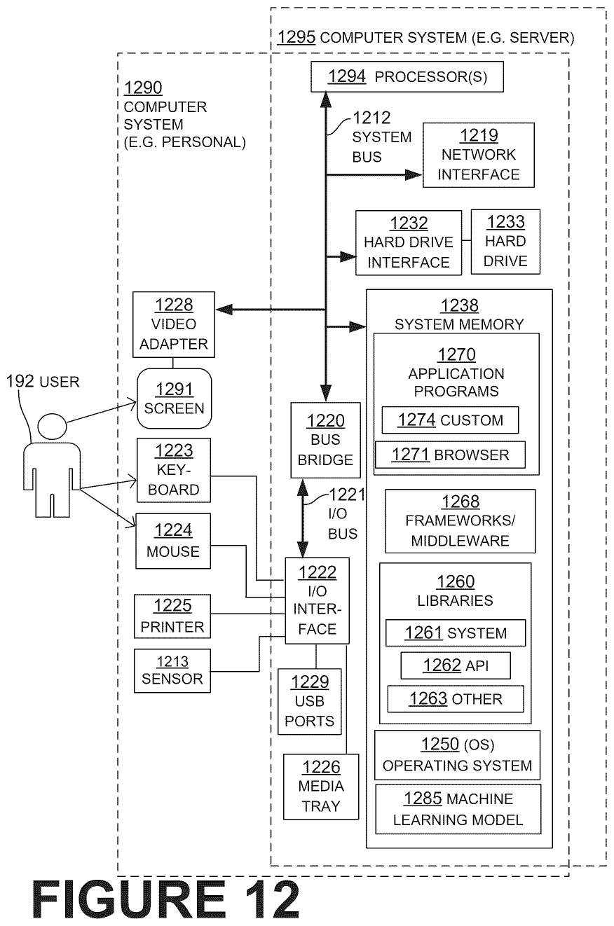

FIG. 12 is a hardware diagram that shows details for a sample computer 1290 system and for a sample computer system 1295. The computer system 1295 may be a server, while the computer system 1290 may be a personal device, such as a personal computer, a desktop computer, a personal computing device such as a laptop computer, a tablet computer, a mobile phone, and so on. Either type may be used for the computer system 195 and 190 of FIG. 1, and/or a computer system that is part of OPF 189.

The computer system 1295 and the computer system 1290 have similarities, which FIG. 12 exploits for purposes of economy in this document. It will be understood, however, that a component in the computer system 1295 may be implemented differently than the same component in the computer system 1290. For instance, a memory in a server may be larger than a memory in a personal computer, and so on. Similarly, custom application programs 1274 that implement embodiments may be different, and so on.

The computer system 1295 includes one or more processors 1294. The processor(s) 1294 are one or more physical circuits that manipulate physical quantities representing data values. The manipulation can be according to control signals, which can be known as commands, op codes, machine code, etc. The manipulation can produce corresponding output signals that are applied to operate a machine. As such, one or more processors 1294 may, for example, include a Central Processing Unit (CPU), a Reduced Instruction Set Computing (RISC) processor, a Complex Instruction Set Computing (CISC) processor, a Graphics Processing Unit (GPU), a Digital Signal Processor (DSP), a Field-Programmable Gate Array (FPGA), an Application Specific Integrated Circuit (ASIC), any combination of these, and so on. A processor may further be a multi-core processor having two or more independent processors that execute instructions. Such independent processors are sometimes called “cores”.

A hardware component such as a processor may also include programmable logic or circuitry that is temporarily configured by software to perform certain operations. For example, a hardware component may include software executed by a general-purpose processor or another type of programmable processor. Once configured by such software, hardware components become specific machines, or specific components of a machine, uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

As used herein, a “component” may refer to a device, physical entity or logic having boundaries defined by function or subroutine calls, branch points, Application Programming Interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. The hardware components depicted in the computer system 1295, or the computer system 1290, are not intended to be exhaustive. Rather, they are representative, for highlighting essential components that can be used with embodiments.

The computer system 1295 also includes a system bus 1212 that is coupled to the processor(s) 1294. The system bus 1212 can be used by the processor(s) 1294 to control and/or communicate with other components of the computer system 1295.

The computer system 1295 additionally includes a network interface 1219 that is coupled to system bus 1212. Network interface 1219 can be used to access a communications network, such as the network 188. Network interface 1219 can be implemented by a hardware network interface, such as a Network Interface Card (NIC), wireless communication components, cellular communication components, Near Field Communication (NFC) components, Bluetooth® components such as Bluetooth® Low Energy, Wi-Fi® components, etc. Of course, such a hardware network interface may have its own software, and so on.

The computer system 1295 also includes various memory components. These memory components include memory components shown separately in the computer system 1295, plus cache memory within the processor(s) 1294. Accordingly, these memory components are examples of non-transitory machine-readable media. The memory components shown separately in the computer system 1295 are variously coupled, directly or indirectly, with the processor(s) 1294. The coupling in this example is via the system bus 1212.

Instructions for performing any of the methods or functions described in this document may be stored, completely or partially, within the memory components of the computer system 1295, etc. Therefore, one or more of these non-transitory computer-readable media can be configured to store instructions which, when executed by one or more processors 1294 of a host computer system such as the computer system 1295 or the computer system 1290, can be designed to or programmed to cause the host computer system to perform operations according to embodiments. The instructions may be implemented by computer program code for carrying out operations for aspects of this document. The computer program code may be written in any combination of one or more programming languages, including an object-oriented programming language such as Java, Smalltalk or the like, and/or conventional procedural programming languages, such as the “C” programming language or similar programming languages such as C++, C Sharp, etc.

The memory components of the computer system 1295 include a non-volatile hard drive 1233. The computer system 1295 further includes a hard drive interface 1232 that is coupled to the hard drive 1233 and to the system bus 1212.

The memory components of the computer system 1295 include a system memory 1238. The system memory 1238 includes volatile memory including, but not limited to, cache memory, registers and buffers. In embodiments, data from the hard drive 1233 populates registers of the volatile memory of the system memory 1238.

In some embodiments, the system memory 1238 has a software architecture that uses a stack of layers, with each layer providing a particular functionality. In this example the layers include, starting from the bottom, an Operating System (OS) 1250, libraries 1260, frameworks/middleware 1268 and application programs 1270, which are also known more simply as applications 1270. Other software architectures may include less, more or different layers. For example, a presentation layer may also be included. For another example, some mobile or special purpose operating systems may not provide a frameworks/middleware 1268.

The OS 1250 may manage hardware resources and provide common services. The libraries 1260 provide a common infrastructure that is used by the applications 1270 and/or other components and/or layers. The libraries 1260 provide functionality that allows other software components to perform tasks more easily than if they interfaced directly with the specific underlying functionality of the OS 1250. The libraries 1260 may include system libraries 1261, such as a C standard library. The system libraries 1261 may provide functions such as memory allocation functions, string manipulation functions, mathematical functions, and the like.

In addition, the libraries 1260 may include API libraries 1262 and other libraries 1263. The API libraries 1262 may include media libraries, such as libraries to support presentation and manipulation of various media formats such as MPREG4, H.264, MP3, AAC, AMR, JPG, and PNG. The API libraries 1262 may also include graphics libraries, for instance an OpenGL framework that may be used to render 2D and 3D in a graphic content on the screen 1291. The API libraries 1262 may further include database libraries, for instance SQLite, which may support various relational database functions. The API libraries 1262 may additionally include web libraries, for instance WebKit, which may support web browsing functionality, and also libraries for applications 1270.

The frameworks/middleware 1268 may provide a higher-level common infrastructure that may be used by the applications 1270 and/or other software components/modules. For example, the frameworks/middleware 1268 may provide various Graphic User Interface (GUI) functions, high-level resource management, high-level location services, and so forth. The frameworks/middleware 1268 may provide a broad spectrum of other APIs that may be used by the applications 1270 and/or other software components/modules, some of which may be specific to the OS 1250 or to a platform.

The application programs 1270 are also known more simply as applications and apps. One such app is a browser 1271, which is a software that can permit the user 192 to access other devices via the Internet, for example while using a Graphic User Interface (GUI). The browser 1271 includes program modules and instructions that enable the computer system 1295 to exchange network messages with a network, for example using Hypertext Transfer Protocol (HTTP) messaging.

The application programs 1270 may include one or more custom applications 1274, made according to embodiments. These can be made so as to cause their host computer to perform operations according to embodiments. Of course, when implemented by software, operations according to embodiments may be implemented much faster than may be implemented by a human mind; for example, tens or hundreds of such operations may be performed per second according to embodiments, which is much faster than a human mind can do.

Other such applications 1270 may include a contacts application, a book reader application, a location application, a media application, a messaging application, and so on. Applications 1270 may be developed using the ANDROID™ or IOS™ Software Development Kit (SDK) by an entity other than the vendor of the particular platform, and may be mobile software running on a mobile operating system. The applications 1270 may use built-in functions of the OS 1250, of the libraries 1260, and of the frameworks/middleware 1268 to create user interfaces for the user 192 to interact with.

The computer system 1295 moreover includes a bus bridge 1220 coupled to the system bus 1212. The computer system 1295 furthermore includes an input/output (I/O) bus 1221 coupled to the bus bridge 1220. The computer system 1295 also includes an I/O interface 1222 coupled to the I/O bus 1221.

For being accessed, the computer system 1295 also includes one or more Universal Serial Bus (USB) ports 1229. These can be coupled to the I/O interface 1222. The computer system 1295 further includes a media tray 1226, which may include storage devices such as CD-ROM drives, multi-media interfaces, and so on.

The computer system 1290 may include many components similar to those of the computer system 1295, as seen in FIG. 12. In addition, a number of the application programs may be more suitable for the computer system 1290 than for the computer system 1295.

The computer system 1290 further includes peripheral input/output (I/O) devices for being accessed by a user more routinely. As such, the computer system 1290 includes a screen 1291 and a video adapter 1228 to drive and/or support the screen 1291. The video adapter 1228 is coupled to the system bus 1212.

The computer system 1290 also includes a keyboard 1223, a mouse 1224, and a printer 1225. In this example, the keyboard 1223, the mouse 1224, and the printer 1225 are directly coupled to the I/O interface 1222. Sometimes this coupling is via the USB ports 1229.

In this context, “machine-readable medium” refers to a component, device or other tangible media able to store instructions and data temporarily or permanently and may include, but is not be limited to, a portable computer diskette, a thumb drive, a hard disk, random-access memory (RAM), read-only memory (ROM), buffer memory, flash memory, optical media, magnetic media, cache memory, an Erasable Programmable Read-Only Memory (EPROM), an optical fiber, a portable compact disc read-only memory (CD-ROM), an optical storage device, a magnetic storage device, or any suitable combination of the foregoing. The machine that would read such a medium includes one or more processors 1294.

The term “machine-readable medium” should be taken to include a single medium or multiple media (e.g., a centralized or distributed database, or associated caches and servers) able to store instructions that a machine such as a processor can store, erase, or read. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methods described herein. Accordingly, instructions transform a general, non-programmed machine into a particular machine programmed to carry out the described and illustrated functions in the manner described.

A computer readable signal traveling from, to, and via these components may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The above-mentioned embodiments have one or more uses. Aspects presented below may be implemented as was described above for similar aspects. (Some, but not all of these aspects have even similar reference numerals, for ease of explanation.)

Operational examples and sample use cases are possible where the attribute of an entity in a dataset is any one of the entity's name, type of entity, a physical location such as an address, a contact information element, an affiliation, a characterization of another entity, a characterization by another entity, an association or relationship with another entity (general or specific instances), an asset of the entity, a declaration by or on behalf of the entity, and so on. Different resources may be produced in such instances, and so on.

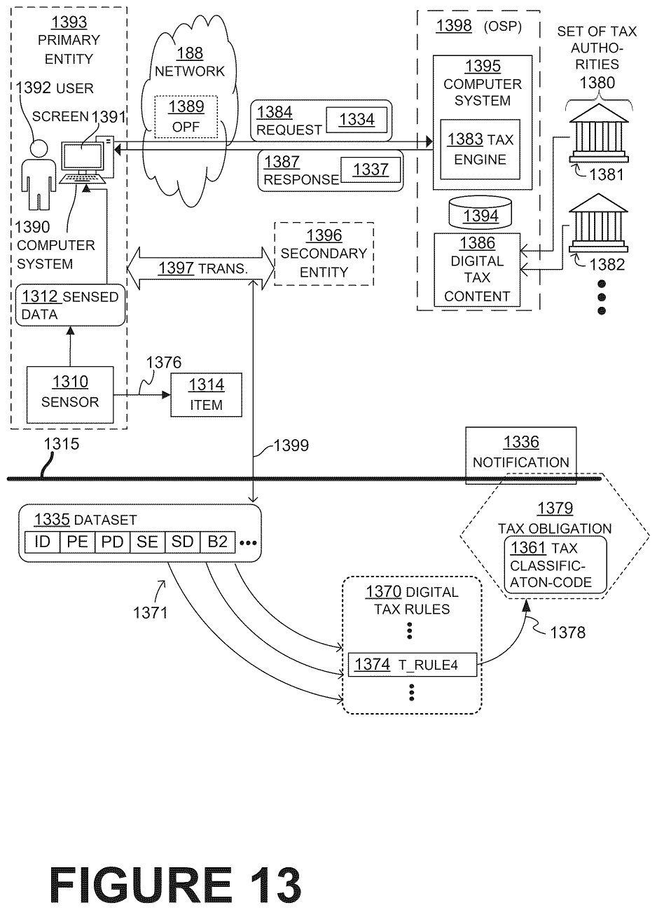

FIG. 13 is a diagram for an operational example where a buy-sell transaction 1397 is a use case of the relationship instance 197. The transaction 1397 is conducted between a primary entity 1393, which is a seller of an item, and a secondary entity 1396, which is the item's buyer. The item may be a product, such as an article or substance that is manufactured or refined for sale, or an aspect of one or more products. A tax obligation 1379 often arises from the transaction 1397 when the item travels across borders, such as borders of states, countries, etc. - in particular an import and/or export tariff or duty must be paid by either the primary entity 1393 or the secondary entity 1396. A computation of the tax obligation 1379 is a use case of producing the resource 179.

It will be recognized that aspects of FIG. 13 have similarities with aspects of FIG. 1. Portions of such aspects may be implemented as described for analogous aspects of FIG. 1. In particular, a thick horizontal line 1315 separates FIG. 13, although not completely or rigorously, into a top portion and a bottom portion. Above the line 1315 are shown elements with emphasis mostly on entities, components, their relationships, and their interactions, while below the line 1315 are shown elements with emphasis mostly on processing of data that takes place often within one or more of the components that are above the line 1315.

Above the line 1315, a computer system 1395 is shown, which is used to help customers, such as a user 1392, with tax compliance. For instance, the user 1392 may log into the computer system 1395 by using credentials, such as a user name, a password, a token, and so on. Further in this example, the computer system 1395 is part of an OSP 1398 that is implemented as a Software as a Service (SaaS) provider, for being accessed by the user 1392 online. As such, the OSP 1398 can be an online service provider for clients. Alternately, the functionality of the computer system 1395 may be provided locally to a user.

The user 1392 may be a single user or multiple users. The user 1392 may use a computer system 1390 that has a screen 1391. In embodiments, the user 1392 and the computer system 1390 are considered part of the primary entity 1393, which is also known as entity 1393. The primary entity 1393 can be a business, such as a seller of items, a reseller, a buyer, a service business, and so on. In such instances, the user 1392 can be an employee, a contractor, or otherwise an agent of the entity 1393. In use cases the entity 1393 is a seller, the secondary entity 1396 is a buyer, and together they are performing the buy-sell transaction 1397. The buy-sell transaction 1397 may involve an operation, such as an exchange of data to form an agreement. This operation can be performed in person, or over the network 188, etc. In such cases the entity 1393 can even be an online seller, but that is not necessary. The transaction 1397 will have data that is known to the entity 1393, similarly with what was described by the relationship instance 197 of FIG. 1.

The computer system 1390 may receive sensed data 1312 from a sensor 1310. The sensor 1310 may be a barcode reader, RFID reader, camera, QR code reader, infrared sensor, or any other type of sensor or group of sensors that are usable to sense an item. The sensor 1310 may be used to sense an item, such as the item 1314 as indicated by the connector 1376. The sensor 1310 transmits sensed data received by sensing the item, such as sensed data 1312, to the computer system 1390. Although a single sensor 1310 is shown in FIG. 13, embodiments are not so limited, and the primary entity 1393 may be associated with multiple sensors that are each able to obtain sensed data regarding items.

In a number of instances, the user 1392 and/or the entity 1393 use software applications to manage their business activities, such as sales, resource management, production, inventory management, delivery, billing, and so on. The user 1392 and/or the entity 1393 may further use accounting applications to manage purchase orders, sales invoices, refunds, payroll, accounts payable, accounts receivable, and so on. Such software applications, and more, may be used locally by the user 1392, or from an Online Processing Facility (OPF) 1389 that has been engaged for this purpose by the user 1392 and/or the entity 1393. In such use cases, the OPF 1389 can be a Mobile Payments system, a Point Of Sale (POS) system, an Accounting application, an Enterprise Resource Planning (ERP) provider, an e-commerce provider, an electronic marketplace, a Customer Relationship Management (CRM) system, and so on.

Businesses have tax obligations to various tax authorities of respective tax jurisdictions. These tax obligations are challenging. A first challenge is in making the related determinations. Tax-related determinations, made for the ultimate purpose of tax compliance, are challenging because the underlying statutes and tax rules and guidance issued by the tax authorities are very complex. There are various types of tax, such as: sales tax; use tax; excise tax; value-added tax; cross-border taxes including customs, tariffs, or duties; and many more. Some types of tax are industry specific. Each type of tax has its own set of rules. Additionally, statutes, tax rules, and rates change often, and new tax rules are continuously added. Compliance becomes further complicated when a taxing authority offers a temporary tax holiday, during which certain taxes are waived.

Tax jurisdictions are defined mainly by geography. Businesses have tax obligations to various tax authorities within the respective tax jurisdictions. There are various tax authorities, such as that of a group of countries, of a single country, of a state, of a county, of a municipality, of a city, of a local district such as a local transit district and so on. So, for example, when a business sells items in transactions that can be taxed by a tax authority, the business may have the tax obligations to the tax authority. These obligations include requiring the business to: a) register itself with the tax authority's taxing agency, b) set up internal processes for collecting a tax obligation in accordance with the tax rules of the tax authority, c) maintain records of the sales transactions and of the collected tax obligations in the event of a subsequent audit by the taxing agency, d) periodically prepare a form (“tax return”) that includes an accurate determination of the amount of the money owed to the tax authority as tax obligations because of the sales transactions, e) file the tax return with the tax authority by a deadline determined by the tax authority, and f) pay (“remit”) that amount of money to the tax authority. In such cases, the filing and payment frequency and deadlines are determined by the tax authority.

A challenge for businesses is that the above-mentioned software applications often cannot provide tax information that is accurate enough for the businesses to be tax compliant with all the relevant tax authorities. The lack of accuracy may manifest itself as errors in the amounts determined to be owed as taxes to the various tax authorities, and it is plain not good to have such errors. For example, businesses that sell products and services have risks whether they over-estimate or under-estimate the tax obligation due from a sale transaction. The tax obligation may include a customs tax, tariff, import tax, export tax, sales tax, etc., for items that travel from one jurisdiction to another, such as items shipped from a first country to a second country. On the one hand, if a seller over-estimates the tax obligation due, then the seller collects more tax obligation from the buyers than was due. Of course, the seller may not keep this surplus tax obligation, but instead must pay it to the tax authorities—if the seller cannot refund it to the buyers. If a buyer later learns that they paid unnecessarily more tax than was due, the seller risks at least harm to their reputation. Sometimes the buyer will have the option to ask the state for a refund of the excess tax by sending an explanation and the receipt, but that is often not done as it is too cumbersome for the amounts of money involved. On the other hand, if a seller under-estimates the tax obligation due, then the seller collects less tax from the buyers, and therefore pays less of their tax obligation to the authorities than was actually due. That is an underpayment of tax that will likely be discovered later, if the tax authority audits the seller. Then the seller will be required to pay the difference, plus fines and/or late fees, because ignorance of the law is not an excuse. Further, one should note that at least a portion of the tax obligation can be considered trust-fund taxes, meaning that the management of a company may be held personally liable for the unpaid tax.

For sales in particular, making correct determinations for of the tax obligation is even more difficult. There are a number of factors that contribute to its complexity.

First, some country, state, and local tax authorities have origin-based tax rules, while others have destination-based tax rules. Accordingly, a tax obligation may be charged from the seller's location, meaning according to the rules of the tax authority of the seller, or from the buyer's location, meaning according to the rules of the tax authority of the buyer.

Second, the various tax authorities assess different, i.e., non-uniform, percentage rates of the sales price as the tax obligation, for the purchase and sale of items that involve their various tax jurisdictions. These tax jurisdictions include various countries, states, counties, cities, municipalities, special taxing jurisdictions, and so on. As the United States switched, largely but not completely, from primarily origin-based sales tax to destination-based tax, the number of tax jurisdictions rapidly multiplied, and the incentives for local governments to implement new and varied tax rules and ever smaller jurisdictions multiplied. As such, there are over 10,000 different tax jurisdictions in the US, with many partially overlapping. Their sizes vary from as large as many square miles to as small as a single building. In parallel, tens of thousands of tax rules and tax rates have been developed. Furthermore, other countries have their own tax rules and tax jurisdictions. Thus, the tax rules and tax rates are exponentially greater for items traveling across the borders of countries.

Third, in some instances no sales tax is due at all because of the type of item sold. For example, in 2018 selling cowboy boots was exempt from sales tax in Texas, but not in New York. This non-uniformity gives rise to numerous individual taxability rules related to various products and services across different tax jurisdictions.

Fourth, in some instances a portion of the tax obligation is not due at all because of who the individual buyer is, and/or what the purchase is for. For example, certain entities are exempt from paying sales tax on their purchases, as long as they properly create and sign an exemption certificate and give it to the seller for each purchase made. Entities that are entitled to such exemptions may include wholesalers, resellers, non-profit charities, educational institutions, etc. Of course, who can be exempt is not exactly the same in each tax jurisdiction. And, even when an entity is entitled to be exempt, different tax jurisdictions may have different requirements for the certificate of exemption to be issued and/or remain valid. And, certificates of exemption may expire after some time, and may need to be renewed or reissued.

Fifth, it can be hard to determine which tax authorities a seller owes the tax obligation tax to. A seller may start with tax jurisdictions that it has a physical presence in, such as a main office, a distribution center or warehouse, an employee working remotely, and so on. Such ties with a tax jurisdiction establish the so-called physical nexus. However, a tax authority such as a state or even a city may set its own nexus rules for when a business is considered to be “engaged in business” with it, and therefore that business is subject to registration and collection of sales taxes. These nexus rules may include different types of nexus, such as affiliate nexus, click-through nexus, cookie nexus, economic nexus with thresholds, and so on. For instance, due to economic nexus, a remote seller may owe sales tax for sales made in the jurisdiction that are a) above a set threshold volume, and/or b) above a set threshold number of sales transactions.

Sixth, it can be hard to determine a grouping for an item which controls the extent of the tariff, customs tax, export tax, import tax, etc. (collectively “tariff”), that either a seller or buyer owes when the item travels between tax jurisdictions. The grouping is represented by a code, such as an HS code, and is determined based on attributes of an item. The HS code is used to determine a tariff for an item based on the destination and source of the item. The tariff is thus an aspect of the tax obligation. However, a seller may not have the expertise to determine which HS code accurately, and each country or other jurisdiction may change the tariff applied to items with certain HS codes at any time. Thus, sellers may not pay the correct tariff due to determining the wrong HS code, due to a change in the import and export laws for the jurisdiction, etc.

The economic nexus mentioned above can be even more complicated. Even where a seller might not have reached any of the thresholds for economic nexus, a number of states are promulgating marketplace facilitator laws that sometimes use such thresholds. According to such laws, intermediaries that are characterized as marketplace facilitators per laws of the state may have an obligation, instead of the seller, to collect sales tax on behalf of their sellers, and remit it to the state. The situation becomes even more complex when a seller sells directly to a state, and also via such an intermediary.

To help with such complex determinations, the computer system 1395 may be specialized for tax compliance. The computer system 1395 may have one or more processors and memory, for example as was described for the computer system 195 of FIG. 1. The computer system 1395 thus implements a tax engine 1383 to make the determinations of tax obligations. The tax engine 1383 may be similar to the service engine 183.

The computer system 1395 may further store locally entity data, i.e., data of user 1392 and/or of entity 1393, either of which/whom may be a customer, and/or a seller or a buyer in a sales transaction. The entity data may include profile data of the customer, and transaction data from which a determination of a tax obligation is desired. In the online implementation of FIG. 13, the OSP 1398 has a database 1394 for storing the entity data. This entity data may be inputted by the user 1392, and/or caused to be downloaded or uploaded by the user 1392 from the computer system 1390 or from the OPF 1389, or extracted from the computer system 1390 or from OPF 1389, and so on. In other implementations, a simpler memory configuration may suffice for storing the entity data.

A digital tax content 1386 is further implemented within the OSP 1398. The digital tax content 1386 can be a utility that stores digital tax rules 1370 for use by the tax engine 1383. As part of managing the digital tax content 1386, there may be continuous updates of the digital tax rules, by inputs gleaned from a set 1380 of different tax authorities 1381, 1382, etc. Updating may be performed by humans, or by computers, and so on. As mentioned above, the number of the different tax authorities in the set 1380 may be very large. In such use cases, tax jurisdictions such as a country, a state, a city, a municipality, etc. correspond to domains discussed earlier in this document.

For a specific determination of a tax obligation, the computer system 1395 may receive one or more datasets. A sample received dataset 1335 is shown just below line 1315. The dataset 1335 has values that can also be called dataset values, and be otherwise examples of what was described for the dataset values of the dataset 135 of FIG. 1. In this example, the computer system 1390 transmits a request 1384 that includes a payload 1334, and the dataset 1335 is received by the computer system 1395 parsing the received payload 1334. In this example the single payload 1334 encodes the entire dataset 1335, but that is not required, as mentioned above.

In this example, the dataset 1335 has been received because it is desired to determine any tax obligations arising from the buy-sell transaction 1397. As such, the sample received dataset 1335 has values that characterize attributes of the buy-sell transaction 1397, as indicated by a correspondence arrow 1399. Accordingly, in this example the sample received dataset 1335 has a value ID for an identity of the dataset 1335 and/or the transaction 1397. The dataset 1335 also has a value PE for the name of the primary entity 1393 or the user 1392, which can be the seller making sales transactions, some perhaps online. The dataset 1335 further has an optional value PD for relevant data of the primary entity 1393 or the user 1392, such as an address, place(s) of business, prior nexus determinations with various tax jurisdictions, and so on. The value PD is optional because it may be possible to look it up from the value PE. The dataset 1335 also has a value SE for the name of the secondary entity 1396, which can be the buyer. The dataset 1335 further has a value SD for relevant data of the secondary entity 1396, entity-driven exemption status, and so on. In some instances, the value SD can be optional, similarly with the value PD. The dataset 1335 has a numerical value B2 for the sale price of the item sold. The dataset 1335 may further have additional dataset values, as indicated by the ellipses in the right side of the dataset 1335. These values may characterize further attributes, such as what item was sold, for example by a Stock Keeping Unit (SKU), how many units of the item were sold in the transaction 1397, a date and possibly also time of the transaction 1397, and so on.

The digital tax rules 1370 are digital in that they are implemented for use by software, similarly with these rules 170. The digital tax rules 1370 can be created so as to accommodate legal tax rules that the set 1380 of different tax authorities 1381, 1382, etc. promulgate to apply within the boundaries of their tax jurisdictions. In the example of this diagram, only one sample digital tax rule is shown explicitly, namely rule T_RULE4 1374. In this diagram, all other such rules are indicated by the vertical ellipses.

Then the computer system 1395 may select a certain one of the digital tax rules 1370. In this example, the rule T_RULE4 1374 is thus selected. The selection of this particular rule is indicated also by the fact that an arrow 1378 begins from that rule. The arrow 1378 is similar to the arrow 178.

The computer system 1395 may thus select the certain rule T_RULE4 1374 responsive to one or more of the dataset values of the dataset 1335. The impact of the dataset 1335 in the selection is indicated by at least some of the arrows 1371, similarly with the arrows 171. For example, it can be recognized that a condition of the digital tax rule T_RULE4 1374 is met by one or more of the values of the dataset 1335. For instance, it can be further determined that, at the time of the sale, the buyer 1396 is located within the boundaries of a tax jurisdiction, that the seller 1393 has nexus with that tax jurisdiction, and that there is no tax holiday.

As such, the computer system 1395 may produce the tax obligation 1379, which is akin to producing the resource 179 of FIG. 1. The tax obligation 1379 can be produced by the computer system 1395 applying the certain digital tax rule T_RULE4 1374, as indicated by the arrow 1378. The impact of the dataset 1335 in producing the tax obligation 1379 is indicated by at least one of the arrows 1371. In this example, the identified certain digital tax rule T_RULE4 1374 may specify that a sales tax is due, the amount is to be determined by a multiplication of the sale price of the value B2 by a specific rate, the tax return form that needs to be prepared and filed, a date by which it needs to be filed, and so on.

The tax obligation 1379 is produced with a tax classification code, such as the tax classification code 1361. A tax classification code may include one or more codes that identify an item for the purposes of calculating a tax obligation for a transaction involving the item. Furthermore, one jurisdiction may have a different tax classification code system than another jurisdiction, and thus different jurisdictions may have different tax classification codes that each describe the same item. Thus, the tax classification code 1361 may include tax classification codes for any jurisdiction associated with the transaction 1397. The tax classification code 1361 is determined by the OSP 1398 by applying item-sensed data for an item, such as the item 1314, to one or more classification machine learning models.

An example of one such tax classification code system is the HS code classification system. An HS code is an international code used by countries to determine a customs obligation for an item. See International Convention of The Harmonized Commodity Description and Coding System, Jun. 13, 1983; and Harmonized Tariff Schedule of the United States (2023) Basic Edition, January 2023; each of which are incorporated by reference herein. In cases where the present application conflicts with a document incorporated by reference, the present application controls. HS codes are numerical codes that classify an item and the country from which the item is leaving. An HS code may have up to 10 digits, which are each used to identify or classify an item, a country, and tariffs that apply to the item. Six digits may be used for the classification of items or commodities, however in some cases countries or other tax jurisdictions add additional digits for this classification. For example, the United States uses ten digits for classifying products for export, where the first six digits are the HS code number, and the next four digits represent other information related to the classification of the item.

The computer system 1395 may then cause a notification 1336 to be transmitted. In the example of FIG. 13, the notification 1336 is caused to be transmitted by the computer system 1395 as an answer to the received dataset 1335. The notification 1336 can be about an aspect of the tax obligation 1379, similarly with the notification 136 of FIG. 1. For instance, the notification 1336 may inform that the tax obligation 1379 has been determined, where it can be found, what it is, or at least a portion or a statistic of its content, and so on.

The notification 1336 can be transmitted to one of an output device and another device that can be the remote device, from which the dataset 1335 was received. The output device may be the screen of a local user or a remote user. The notification 1336 may thus cause a desired image to appear on the screen, such as within a Graphical User Interface (GUI) and so on. The other device may be a remote device, as in this example. In particular, the computer system 1395 causes the notification 1336 to be communicated by being encoded as a payload 1337, which is carried by a response 1387. The response 1387 may be transmitted via the network 188 responsive to the received request 1384. The response 1387 may be transmitted to the computer system 1390, or to the OPF 1389, and so on. As such, the other device can be the computer system 1390, or a device of the OPF 1389, or the screen 1391 of the user 1392, and so on. In this example the single payload 1337 encodes the entire notification 1336, but that is not required, similarly with what is written above about encoding datasets in payloads. Of course, along with the aspect of the tax obligation 1379, it is advantageous to embed in the payload 1337 the ID value and/or one or more values of the dataset 1335. This will help the recipient correlate the response 1387 that they receive to their request 1384, and therefore match the received aspect of the tax obligation 1379 as the answer to the transmitted dataset 1335.

The digital tax rules 1370 can be implemented or organized in different ways. For example, these digital tax rules 1370 may have applicability conditions that relate to geographical boundaries, effective dates with possible temporary exceptions, item classification into categories, differently-treated parties, and so on, for determining where and when a certain digital tax rule is to be selected and applied, to determine the tax obligation 1379. These conditions may be expressed as logical conditions with ranges, dates, other data, and so on. Values of the dataset 1335 can be iteratively tested against these logical conditions according to arrows 1371. In such cases, the applicable tax rules may indicate how to compute one or more tax obligations, such as to indicate different types of taxes that are due, rules, rates, exemption requirements, reporting requirements, remittance requirements, the actual amounts of tax obligations, etc.

As with the digital resource rules 170, the digital tax rules 1370 may also be complex. While a certain one of them is eventually selected and applied to determine the tax obligation, more than one of them may be used for selecting that certain one.

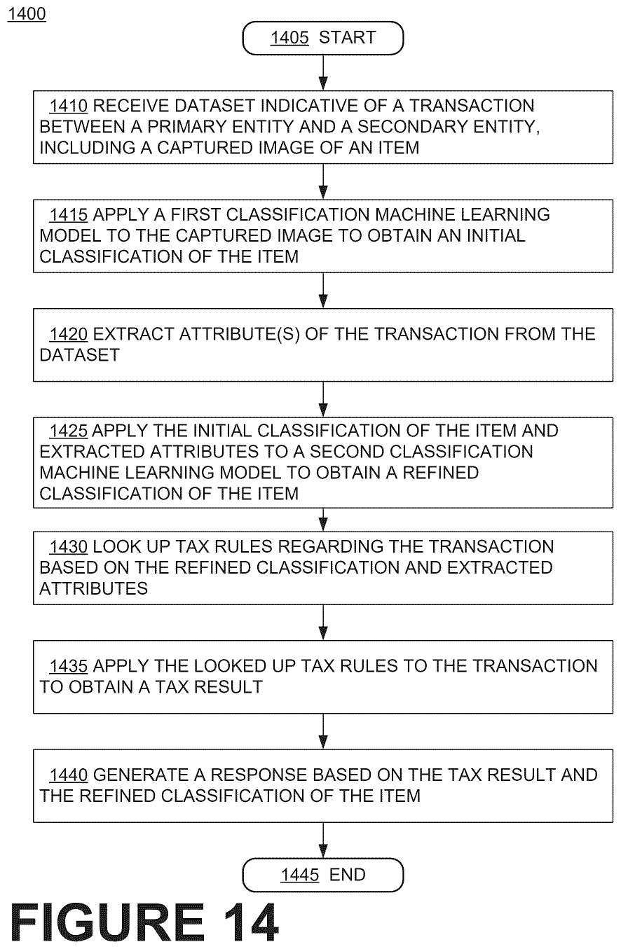

FIG. 14 is a flowchart for illustrating a sample method 1400 for receiving data derived from item-sensed data related to a transaction to classify an item included in the transaction, according to various embodiments described herein. In some embodiments, the actions performed in the method 1400 are similar to the actions performed in the method 600.

The process 1400 begins at 1405.

At 1410, the OSP 1398 receives a dataset indicative of a transaction between a primary entity and a secondary entity including a captured image of an item. In some embodiments, the dataset includes item-sensed data of the item other than a captured image.

At 1415, OSP 1398 applies a first classification machine learning model to the captured image to obtain an initial classification of the item.

At 1420, the OSP 1398 extracts one or more attributes of the transaction from the dataset.

At 1425, the OSP 1498 applies the initial classification of the item and extracted attributes of the transaction to a second classification machine learning model to obtain a refined classification of the item.

At 1430, OSP 1398 looks up tax rules regarding the transaction based on the refined classification and the extracted attributes.

At 1435, the OSP 1398 applies the looked up tax rules to the transaction to obtain a tax result.

At 1440, OSP 1398 generates a response based on the tax result and the refined classification of the item.

At 1445, the process 1400 ends.

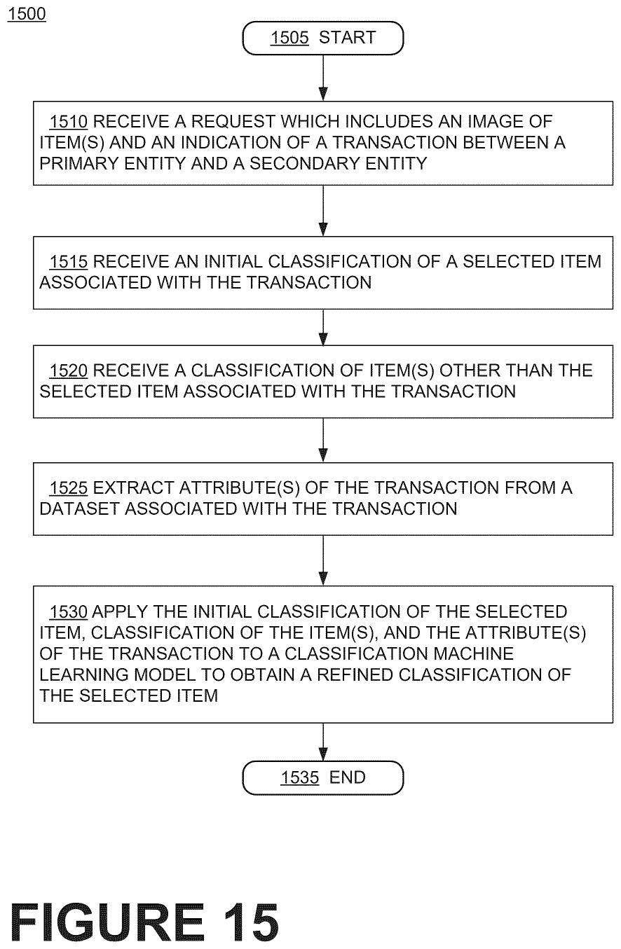

FIG. 15 is a flowchart for illustrating a sample method 1500 for generating a refined classification for an item in a transaction, according to various embodiments described herein. In some embodiments, the actions performed in the method 1500 are similar to the actions performed in the method 700.

The method 1500 starts at 1505.

At 1510, the OSP 1398 receives a request which includes an image of the item and an indication of a transaction between a primary entity and a secondary entity.

At 1515, the OSP 1398 receives an initial classification of a selected item associated with the transaction.

At 1520, the OSP 1398 receives a classification of one or more items other than the selected item associated with the transaction.

At 1525, the OSP 1398 extracts one or more attributes of the transaction from a dataset associated with the transaction.

At 1530, the OSP 1398 applies the initial classification of the selected item, classification of the one or more items, and the attributes of the transaction to a second classification machine learning model to obtain a refined classification of the selected item.

At 1535, the process 1500 ends.

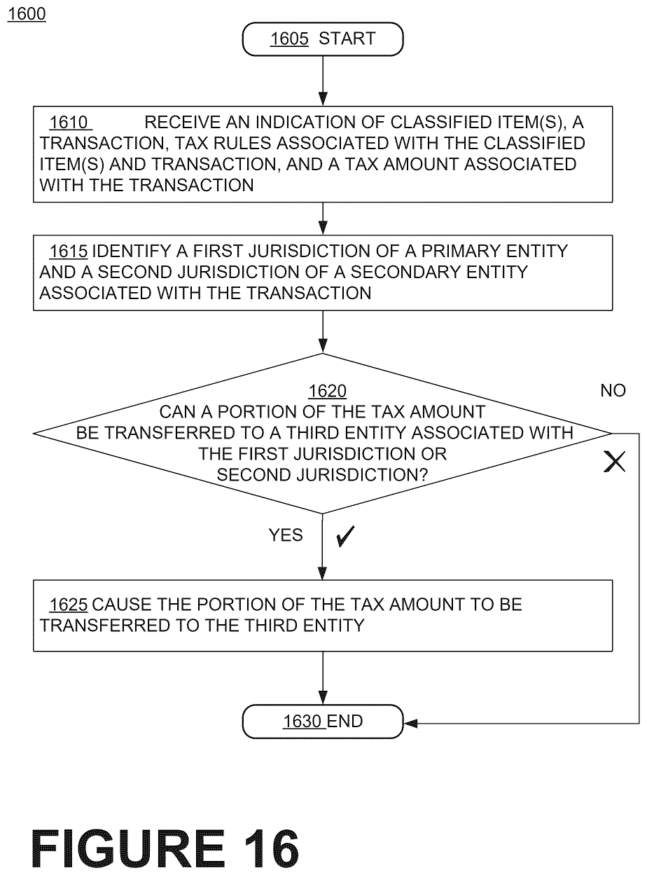

FIG. 16 is a flowchart for illustrating a sample method 1600 for determining whether a portion of a resource associated with a transaction is able to be transferred to a third entity, according to various embodiments described herein. In some embodiments, the actions performed in the method 1600 are similar to the actions performed in the method 800.

The method 1600 begins at 1605.

At 1610, the OSP 1398 receives an indication of one or more classified items, a transaction, tax rules associated with the classified items and transaction, and a tax amount associated with the transaction.

At 1615, the OSP 1398 identifies a first jurisdiction of a primary entity and a second jurisdiction of a secondary entity associated with the transaction. In some embodiments, the first jurisdiction and second jurisdiction are the same jurisdiction.

At 1620, the OSP 1398 determines whether a portion of the tax amount can be transferred to a third entity associated with the first jurisdiction, the second jurisdiction, or some combination thereof, based on the tax rules, the transaction, and the refined classification of the one or more items. In some embodiments, the portion of the tax amount is a split tax payment for remitting a tax amount to the third entity within a period of time after the transaction is completed that occurs before the tax amount is normally due. For example, the portion of the tax amount may be remitted to the third entity within days of the completion of the transaction, immediately after the transaction, etc., instead of waiting for the date on which taxes incurred during the year are normally due. If the portion of the tax amount cannot be transferred to the third entity, the method 1600 proceeds to act 1630, otherwise the method 1600 proceeds to act 1625.

### At 1625, the OSP 1398 causes the portion of the tax amount to be transferred to the third entity.

At 1630, the method 1600 ends.

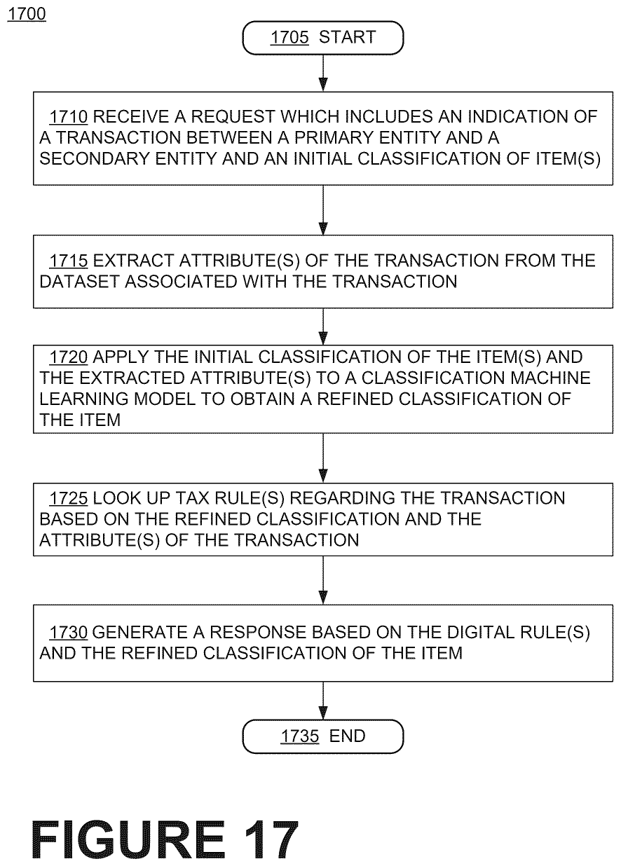

FIG. 17 is a flowchart for illustrating a sample method 1700 for classifying an item associated with a transaction based on data derived from a dataset that includes an initial classification of the item, according to various embodiments described herein. In some embodiments, the actions performed in the method 1700 are similar to the actions performed in the method 1000.

The method 1700 begins at 1705.

At 1710, the OSP 1398 receives a request which includes an indication of a transaction between a primary entity and a secondary entity and an initial classification of one or more items associated with the transaction.

At 1715, the OSP 1398 extracts one or more attributes of the transaction from the dataset associated with the transaction.

At 1720, the OSP 1398 applies the initial classification of the items and the extracted attributes to a classification machine learning model to obtain a refined classification of the item.

At 1725, the OSP 1398 looks up tax rules regarding the transaction based on the refined classification and the attributes of the transaction.

At 1730, the OSP 1398 generates a response based on the digital rules and the refined classification of the item.

The method 1700 ends at 1735.

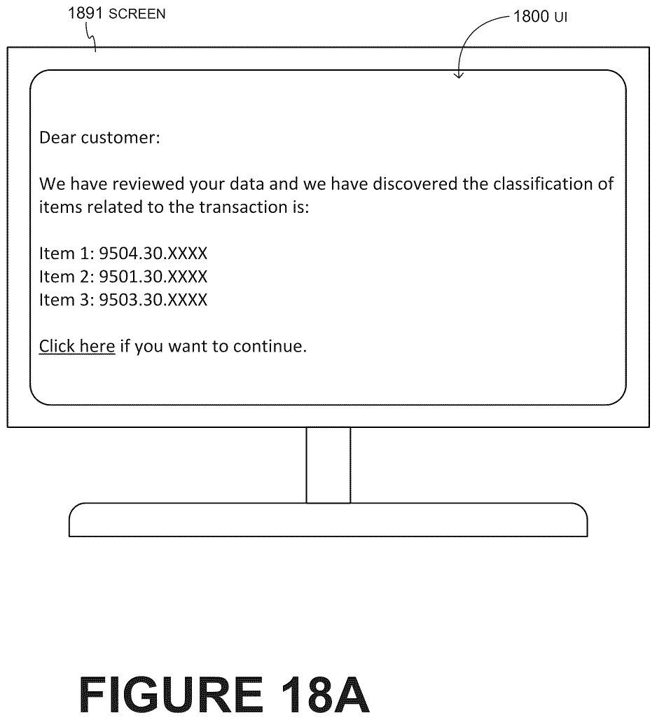

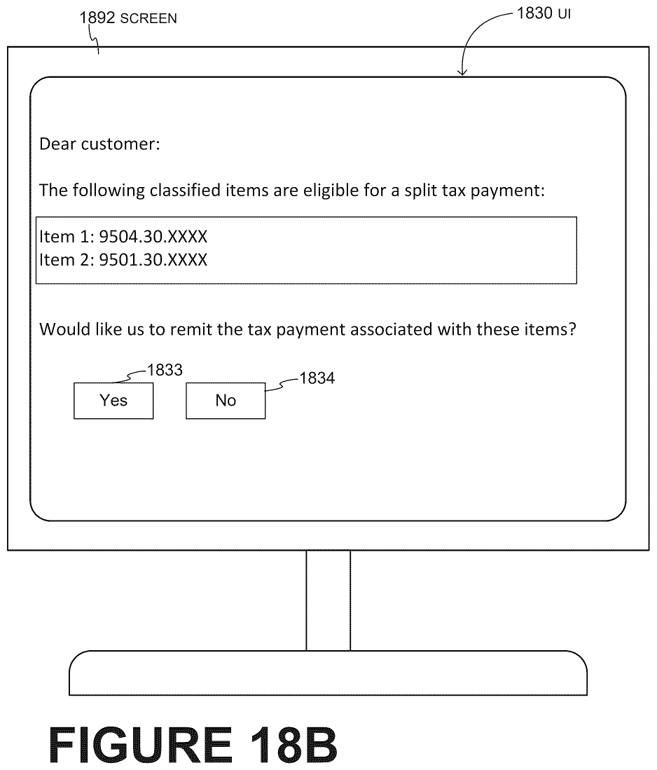

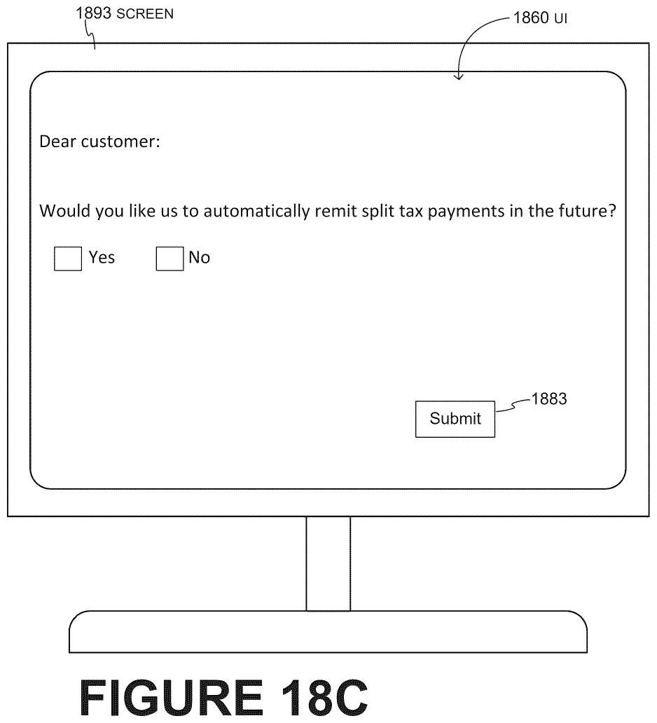

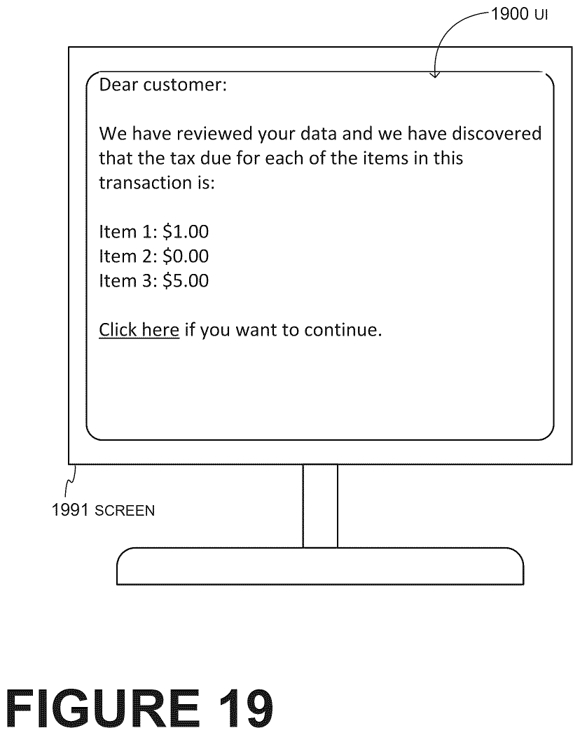

A primary entity may use the User Interfaces (UIs) described in FIGS. 18A-19 to transmit data related to an item and a transaction to an OSP, such as the OSP 198 or OSP 1398. The OSP communicates with a user associated with the primary entity via the UIs to obtain information regarding the item and transaction to determine tax classification code for the item. The OSP may cause the UIs to present prompts to the user associated with the primary entity and to receive answers to the prompts. The OSP may also cause the UIs to present tax classification code and other information related to the item or transaction to the user.

FIG. 18A is a display diagram showing sample view of a first User Interface (“UI”) 1800, shown on a screen, according to various embodiments described herein. The UI 1800 displays data to a user indicating the tax classification codes for items associated with a transaction between a primary entity and a secondary entity. In some embodiments, the UI 1800 is generated after a sensor detects item-sensed data for items associated with a transaction, such as items that are near a point-of-sales system, cash register, etc., and after a computer system associated with a primary entity transmitted the item-sensed data and data associated with the transaction to an OSP. In some embodiments, the sensed-data includes: an image; sound data; infrared data; data indicating a code for the item, such as a bar code, QR code, etc.; a depth-map for one or more items; other data associated with an item that can be sensed by a sensor; or some combination thereof. In some embodiments, the computing system associated with the primary entity activates the sensor to obtain the item-sensed data when a transaction begins, when an item is sensed by the sensor, when a transaction is completed, in response to input from the user via a user interface, or some combination thereof. In some embodiments, the user submits the item-sensed data via a user interface. After the user interacts with the UI 1800, the UI 1800 may be altered, changed, replaced, etc., by a different UI.

FIG. 18B is a display diagram showing sample view of a second User Interface 1830, shown on a screen, according to various embodiments described herein. The UI 1830 displays information to a user regarding whether items classified by the OSP are eligible for a split tax payment and includes a Yes button 1833 and a No button 1834. Interacting with the Yes button 1833 causes a computer system, such as the computer system 190 or 1390, presenting the UI 1860 to cause the split tax payment to be remitted for the items displayed in the UI 1830. The computer system may cause the split tax payment to be remitted by transmitting instructions to the OSP to cause the transfer of the tax payment from an account associated with the primary entity to an account associated with an entity that receives tax payments. Interacting with the No button 1834 does not result in causing the split tax payment to be remitted. After the user interacts with the UI 1830, the UI 1830 may be altered, changed, replaced, etc., by a different UI.

FIG. 18C is a display diagram showing sample view of a third User Interface 1860, shown on a screen, according to various embodiments described herein. The UI 1860 is a sample interface through which a user may choose to instruct the OSP to automatically remit split tax payments if an item associated with a transaction is eligible for such a payment. The UI 1860 includes “Yes” and “No” checkboxes for the user to make a selection and a submit button 1883. Interacting with the submit button 1883 causes the computing system to transmit instructions to the OSP regarding whether to automatically remit split tax payments based on whether the “Yes” or “No” checkbox is checked. After the user interacts with the UI 1860, the UI 1860 may be altered, changed, replaced, etc., by a different UI.

FIG. 19 is a display diagram showing sample view of a fourth User Interface 1900, shown on a screen, according to various embodiments described herein. The UI 1900 is a sample interface that indicates to a user the tax due for each item in a transaction. After the user interacts with the UI 1900, the UI 1900 may be altered, changed, replaced, etc., by a different UI.

In the methods described above, each operation can be performed as an affirmative act or operation of doing, or causing to happen, what is written that can take place. Such doing or causing to happen can be by the whole system or device, or just one or more components of it. It will be recognized that the methods and the operations may be implemented in a number of ways, including using systems, devices and implementations described above. In addition, the order of operations is not constrained to what is shown, and different orders may be possible according to different embodiments. Examples of such alternate orderings may include overlapping, interleaved, interrupted, reordered, incremental, preparatory, supplemental, simultaneous, reverse, or other variant orderings, unless context dictates otherwise. Moreover, in certain embodiments, new operations may be added, or individual operations may be modified or deleted. The added operations can be, for example, from what is mentioned while primarily describing a different system, apparatus, device or method.

A person skilled in the art will be able to practice the present invention in view of this description, which is to be taken as a whole. Details have been included to provide a thorough understanding. In other instances, well-known aspects have not been described, in order to not obscure unnecessarily this description.

Some technologies or techniques described in this document may be known. Even then, however, it does not necessarily follow that it is known to apply such technologies or techniques as described in this document, or for the purposes described in this document.

This description includes one or more examples, but this fact does not limit how the invention may be practiced. Indeed, examples, instances, versions or embodiments of the invention may be practiced according to what is described, or yet differently, and also in conjunction with other present or future technologies. Other such embodiments include combinations and sub-combinations of features described herein, including for example, embodiments that are equivalent to the following: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the features incorporated in such combinations and sub-combinations.

A number of embodiments are possible, each including various combinations of elements. When one or more of the appended drawings—which are part of this specification—are taken together, they may present some embodiments with their elements in a manner so compact that these embodiments can be surveyed quickly. This is true even if these elements are described individually extensively in this text, and these elements are only optional in other embodiments.

In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the claimed invention.

In this document, the phrases “constructed to”, “adapted to” and/or “configured to” denote one or more actual states of construction, adaptation and/or configuration that is fundamentally tied to physical characteristics of the element or feature preceding these phrases and, as such, reach well beyond merely describing an intended use. Any such elements or features can be implemented in a number of ways, as will be apparent to a person skilled in the art after reviewing the present disclosure, beyond any examples shown in this document.

Parent patent applications: Any and all parent, grandparent, great-grandparent, etc. patent applications, whether mentioned in this document or in an Application Data Sheet (“ADS”) of this patent application, are hereby incorporated by reference herein as originally disclosed, including any priority claims made in those applications and any material incorporated by reference, to the extent such subject matter is not inconsistent herewith.

Reference numerals: In this description a single reference numeral may be used consistently to denote a single item, aspect, component, or process. Moreover, a further effort may have been made in the preparation of this description to use similar though not identical reference numerals to denote other versions or embodiments of an item, aspect, component or process that are identical or at least similar or related. Where made, such a further effort was not required, but was nevertheless made gratuitously so as to accelerate comprehension by the reader. Even where made in this document, such a further effort might not have been made completely consistently for all of the versions or embodiments that are made possible by this description. Accordingly, the description controls in defining an item, aspect, component or process, rather than its reference numeral. Any similarity in reference numerals may be used to infer a similarity in the text, but not to confuse aspects where the text or other context indicates otherwise.

The claims of this document define certain combinations and sub-combinations of elements, features and acts or operations, which are regarded as novel and non-obvious. The claims also include elements, features and acts or operations that are equivalent to what is explicitly mentioned. Additional claims for other such combinations and sub-combinations may be presented in this or a related document. These claims are intended to encompass within their scope all changes and modifications that are within the true spirit and scope of the subject matter described herein. The terms used herein, including in the claims, are generally intended as “open” terms. For example, the term “including” should be interpreted as “including but not limited to,” the term “having” should be interpreted as “having at least,” etc. If a specific number is ascribed to a claim recitation, this number is a minimum but not a maximum unless stated otherwise. For example, where a claim recites “a” component or “an” item, it means that the claim can have one or more of this component or this item.

In construing the claims of this document, 35 U.S.C. § 112(f) is invoked by the inventor(s) only when the words “means for” or “steps for” are expressly used in the claims. Accordingly, if these words are not used in a claim, then that claim is not intended to be construed by the inventor(s) in accordance with 35 U.S.C. § 112(f).

1. A system, comprising:
one or more processors;
one or more non-transitory computer-readable storage media coupled to the one or more processors, the media having stored thereon instructions which, when executed by the one or more processors, result in operations including at least:
receiving, by the one or more processors, a dataset indicative of a relationship instance between a primary entity and a secondary entity, the dataset including item-sensed data for one or more items associated with the relationship instance;
applying, by the one or more processors, a first classification machine learning model to the item-sensed data to obtain an initial classification of at least one item of the one or more items;
extracting, from the dataset, one or more attributes of the relationship instance;
applying, by the one or more processors, the first classification of the at least one item and the extracted attributes of the relationship instance to a second classification machine learning model to obtain a refined classification of the at least one item;
looking up, by the one or more processors, one or more digital rules regarding the relationship instance based on the refined classification of the at least one item and the extracted attributes of the relationship instance; and
generating, by the one or more processors, a response to the dataset based on the one or more digital rules and the refined classification of the at least one item.

2. The system of claim 1, in which the instructions, when executed by the one or more processors to obtain the refined classification of the at least one item, result in further operations including:
receiving an indication of one or more classifications for one or more items for which item-sensed data is included in the dataset that are not the at least one item; and
applying the first classification of the at least one item, the extracted attributes of the relationship instance, and the one or more classifications, to the second classification machine learning model.

3. The system of claim 1, in which the item-sensed data for at least one item of the one or more items associated with the relationship instance includes an image depicting the at least one item.

4. The system of claim 1, in which the item-sensed data for at least one item of the one or more items associated with the relationship instance includes a depth map for the at least one item.

5. The system of claim 1, in which the first classification machine learning model is a computer-vision model.

6. The system of claim 1, in which the second classification machine learning model is a Bayesian Regression model.

7. The system of claim 1, in which the instructions, when executed by the one or more processors to generate the response, result in further operations including:
identifying a first domain associated with the primary entity based on the dataset;
identifying a second domain associated with the secondary entity based on the dataset;
identifying a resource associated with the relationship instance;
determining whether a portion of the resource is able to be transferred to a third entity associated with at least one of the first domain and the second domain based on the relationship instance and the one or more digital rules regarding the relationship instance.

8. The system of claim 7, in which the instructions, when executed by the one or more processors, result in further operations including:
based on a determination that the portion of the resource is able to be transferred to the third entity:
generating data for transferring the portion of the resource to the third entity based on the one or more digital rules, the resource associated with the relationship instance, and the third entity.

9. The system of claim 7, in which the instructions, when executed by the one or more processors, result in further operations including:
based on a determination that the portion of the resource is able to be transferred to the third entity:
automatically causing the portion of the resource to be transferred to the third entity.

10. The system of claim 1, in which the one or more attributes of the relationship instance include at least one of:
a location associated with the relationship instance;
an entity type of the primary entity;
a weight of one or more items associated with the relationship instance;
a shape of one or more items associated with the relationship instance;
an entity type of the secondary entity; or
a number of items associated with the relationship instance.

11. The system of claim 1, in which the instructions, when executed by the one or more processors to obtain the refined classification of the at least one item, result in further operations including:
receiving an indication of one or more past relationship instances associated with the primary entity for which one or more items were classified;
identifying classification data associated with classifying one or more items associated with the one or more past relationship instances; and
applying the first classification, the extracted attributes of the relationship instance, and the classification data to the second classification machine learning model to obtain the refined classification of the at least one item.

12. The system of claim 1, in which the instructions, when executed by the one or more processors, result in further operations including:
receiving an indication of data describing a plurality of items associated with one or more primary entities, the data describing the plurality of items including item-sensed data for each item of the plurality of items;
training the first classification machine learning model to obtain an initial classification of an item based on the data describing the plurality of items; and
training the second classification machine learning model to obtain a refined classification of an item based on data describing the plurality of items and one or more initial classifications generated by the first classification machine learning model.

13. The system of claim 1, in which at least a portion of the one or more processors are one or more processors of a computing device associated with the primary entity,
in which applying the first classification machine learning model to the item-sensed data to obtain the initial classification is performed by the computing device associated with the primary entity, and
in which the dataset includes the initial classification.

14. The system of claim 1, in which the instructions, when executed by the one or more processors, result in further operations including:
receiving one or more outputs of the first classification model and one or more outputs of the second classification model;
verifying the one or more outputs of the first classification model based on relationship instances associated with the one or more outputs of the first classification model;
verifying the one or more outputs of the second classification model based on one or more digital rules and one or more relationship instances associated with the one or more outputs;
retraining the first classification model based on the verification of the one or more outputs of the first classification model and the one or more outputs of the first classification model; and
retraining the second classification model based on the verification of the one or more outputs of the second classification model and the one or more outputs of the second classification model.

15. The system of claim 1, in which the instructions, when executed by the one or more processors to extract one or more attributes of the relationship instance, result in further operations including:
identifying one or more aspects of the relationship instance based on output generated by a large language model as a result of applying data describing the relationship instance to the large language model; and
extracting one or more attributes of the relationship instance based on the identified one or more aspects of the relationship instance.

16-45. (canceled)
